(19) United States
(12) Patent Application Publication
(10) Pub. No.: US 2025/0089635 A1
(43) Pub. Date: Mar. 20, 2025

(54) HYDROPONIC SUBSTRATE

(71) Applicant: PROFILE PRODUCTS LLC, Buffalo Grove, IL (US)

(72) Inventors: Michael D. ROBESON, Windsor, CO (US); Ryan Michael KNAUER, Hickory, NC (US); Daniel Scott NORDEN, Belton, SC (US); Stanton Reid SMITH, Maiden, NC (US); Gary Lane BOWERS, Jonesborough, TN (US)

(73) Assignee: PROFILE PRODUCTS LLC, Buffalo Grove, IL (US)

(21) Appl. No.: 18/701,243

(22) PCT Filed: May 26, 2023
(86) PCT No.: PCT/US2023/023749

§ 371 Date: Apr. 14, 2024

Related U.S. Application Data
(60) Provisional application No. 63/346,080, filed on May 26, 2022.

(51) Int. Cl. A01G 24/25

(52) U.S. Cl. CPC A01G 24/25

(57) ABSTRACT

A hydroponic substrate includes a three-dimensional self-supporting, vertically stable fibrous body having an inner portion including a first fiber density and an outer crust portion including densified fiber having a second fiber density, the second fiber density being different than the first fiber density, the inner portion and the outer crust portion forming horizontal and vertical liquid pathways structured to distribute liquid throughout the body.

### CROSS-REFERENCE TO RELATED APPLICATIONS

This application claims the benefit of U.S. provisional application Ser. No. 63/346,080, filed May 26, 2022, the disclosure of which is incorporated in its entirety by reference herein.

### TECHNICAL FIELD

The present disclosure relates to a hydroponic substrate and methods of making and using the same.

### BACKGROUND

Hydroponics is a subset of horticulture relating to a method of growing plants without soil, using mineral nutrient solutions in a water solvent. The plants may be grown without a substrate altogether such that only the plant roots are exposed to the mineral solution. Alternatively, the roots may be supported by a medium or substrate which is free of soil. Numerous types of substrates have been tested. For example, rock wool mats, cubes, and slabs have become popular. Other substrates include vermiculite, coir peat, or perlite. Yet, rock wool, peat, and other materials are now recognized as unsustainable options, and demand for hydroponic growing has increased.

### SUMMARY

In one embodiment, a hydroponic substrate is disclosed. The substrate may include a three-dimensional self-supporting fibrous structure including two or more compressed layers stacked on top of one another. Each layer may include an inner portion having a first fiber density and an outer crust portion comprising densified fiber having a second fiber density, the second fiber density being different than the first fiber density. The hydroponic substrate may be hydratable and structured to have vertical stability after hydration. The densified fiber may have a pore structure arranged to form lateral liquid pathways. The hydroponic substrate may be free of a binder. The two or more compressed layers may have independently different properties. The hydroponic substrate may include wood fiber. The two or more compressed layers may have generally the same dimensions and form a grow cube. The first fiber density to the second fiber density ratio may be about 0.3-0.5. At least one of the two or more compressed layers may be about 3-10 mm thick. The substrate may be rewettable while being surfactant-free. The densified fiber may include smaller pores on average than the inner portion. The hydroponic substrate may be free of a wrapping. The hydroponic substrate may include wood, bark, coir, sisal, jute, straw, rice hulls, hemp, alfalfa, flax, peat, hammermilled fiber, sawdust, compost, manure, paper, biostimulant(s), fertilizer(s), ceramic particle(s), or a combination thereof.

In another embodiment, a hydroponic substrate is disclosed. The substrate may include a plurality of fibrous compressed layers in communication with one another. The substrate may have a dry state defined by a first moisture content and dry state thickness and a second hydrated state defined by a second moisture content and hydrated state thickness. The dry state moisture content and thickness may be lower than the hydrated state moisture content and thickness. The layers may be stacked on top of one another. The substrate may be a self-supporting substrate in the dry state and the hydrated state. The first moisture content may be up to about 20 wt. % and the second moisture content may be greater than 20 wt. %. The first moisture content may be up to about 10 wt. %. The plurality of layers may include at least three layers. The hydroponic substrate may form a self-supporting slab having vertical and horizontal stability. The hydroponic substrate may further include a wrapping dimensioned to accommodate the hydrated state thickness. The hydroponic substrate may be rewettable. The hydroponic substrate may include wood, bark, coir, sisal, jute, straw, rice hulls, hemp, alfalfa, flax, peat, hammermilled fiber, sawdust, compost, manure, paper, biostimulant(s), fertilizer(s), ceramic particle(s), or a combination thereof. The hydroponic substrate may be free of a surfactant.

In an alternative embodiment, a hydroponic substrate is disclosed. The hydroponic substrate may include a plurality of discreet layers stacked on top of one another such that the layers remain stationary with respect to one another. Each layer may include compressed fibrous material structured to have lateral liquid pathways and horizontal liquid pathways. The discreet layers may cooperate together to form the hydroponic substrate. The hydroponic substrate may also include a wrapping enclosing the plurality of discreet layers. The plurality of discreet layers may have independently different properties. The plurality of discreet layers may include a top layer having a substantially uniform and level surface. The wrapping may be permeable. The layers may have substantially even density throughout their length. The wrapping may be biodegradable. The wrapping may be a loose wrapping covering a top side of the substrate. The hydroponic substrate may include wood, bark, coir, sisal, jute, straw, rice hulls, hemp, alfalfa, flax, peat, hammermilled fiber, sawdust, compost, manure, paper, biostimulant(s), fertilizer(s), ceramic particle(s), or a combination thereof. The hydroponic substrate may be free of a surfactant. The discreet layers may be secured together. The securing may include a dissolvable film.

In another embodiment, a hydroponic substrate is disclosed. The hydroponic substrate may include a three-dimensional self-supporting, vertically stable fibrous body including an inner portion having a first fiber density and an outer crust portion comprising densified fiber having a second fiber density. The second fiber density may be different than the first fiber density. The inner portion and the outer crust portion may form horizontal and vertical liquid pathways structured to distribute liquid throughout the body. The hydroponic substrate may be free of a wrapping. The hydroponic substrate may be a single layer hydroponic substrate. The hydroponic substrate may include wood, bark, coir, sisal, jute, straw, rice hulls, hemp, alfalfa, flax, peat, hammermilled fiber, sawdust, compost, manure, paper, biostimulant(s), fertilizer(s), ceramic particle(s), or a combination thereof. A ratio of the first fiber density to the second fiber density may be about 0.3-0.5. The hydroponic substrate may be rewettable while being free of a surfactant. The outer crust may have a smaller average pore size than an average pore size of the inner portion. The hydroponic substrate may include a single type of fiber material. The hydroponic substrate may be sterile.

In yet another embodiment, a method of forming a hydroponic substrate is disclosed. The method may include providing loose fiber on a sheet insertable into a press. The method may also include forming a crust as a top and bottom outer portion of a substrate layer, the crust having smaller average pore size and greater density than a remainder of the substrate layer, by pressing the loose fiber in the press for at least one cycle while supplying heat and fluctuating the amount of pressure within the cycle. The method may further include removing the pressed substrate layer from the press. The forming may include supplying additional moisture. The loose fiber may have an initial moisture content of about 10 wt. % lower than the moisture content of the pressed substrate. The method may also include a preheating step of increasing temperature of the loose fiber, the sheet, or both prior to insertion into the press. The method may also include comprising cutting, layering, and/or stacking of the pressed substrate layer to form a multi-layer hydroponic substrate. The method may include building a substrate from one or more substrate layers and securing the substrate layers together. The method may include inserting the hydroponic substrate in a wrapping. The providing may include sandwiching the loose fiber between two metal sheets. The forming may include even distribution of heat throughout a volume of the loose fiber.

In another embodiment, a hydroponic substrate is disclosed. The hydroponic substrate may include a three-dimensional self-supporting fibrous structure including two or more compressed layers disposed in a vertically stacked arrangement. Each layer may include an inner portion having a first fiber density and an outer crust portion comprising a second fiber density, the second fiber density being at least about 2.5% higher than the first fiber density.

### BRIEF DESCRIPTION OF THE DRAWINGS

FIG. 1A is a photograph of a non-limiting example of a hydroponic substrate layer according to one or more embodiments disclosed herein;

FIG. 1B shows the hydroponic substrate of FIG. 1A in a non-limiting example of a wrapping;

FIG. 1C shows a hydroponic substrate disclosed herein in a non-limiting example wrapping with cut-outs for grow cubes and drill holes for drip stakes;

FIG. 2 is a photograph of a non-limiting example of a hydroponic substrate slab formed from three layers according to one or more embodiments;

FIG. 3A provides an enlarged view of the slab shown in FIG. 2;

FIG. 3B shows the slab of FIG. 2 inserted in a non-limiting example of a wrapping;

FIG. 4 shows a non-limiting example of a hydroponic substrate layer prepared on a batch press according to a method disclosed herein;

FIG. 5 is a non-limiting example of a hydroponic substrate slab having a number of layers having crusts;

FIG. 6 shows a non-limiting example of a hydroponic substrate slab having a number of layers free of crusts;

FIGS. 7 and 8 show non-limiting examples of layered hydroponic substrate slabs according to one or more embodiments disclosed herein in a hydroponic system including irrigation devices and grow cubes with plants;

FIGS. 9 and 10 show non-limiting examples of grow cubes made from hydroponic substrates, each having a non-limiting example of a wrapping;

FIG. 11 shows a non-limiting example of a layered hydroponic substrate according to one or more embodiments disclosed herein;

FIG. 12 shows the layered hydroponic substrate of FIG. 11 enclosed in a non-limiting example of a wrapping;

FIGS. 13A-13C show a non-limiting example of a grow cube made from a hydroponic substrate disclosed herein illustrating root development of a seedling in the grow cube over time;

FIG. 14 is a plot of volumetric water content (VWC) versus number of layers of hydroponic substrate samples 43, 47, 51, 55, 59, and 63;

FIG. 15 is a plot of expanded hydrated substrate height versus number of layers of hydroponic substrate samples 42, 46, 50, 54, 58, and 62;

FIG. 16 is a photograph of a non-limiting example loose fiber used to make hydroponic substrate disclosed herein;

FIG. 17 show a non-limiting example of a container utilized during the batch process described herein;

FIGS. 18 and 19 show manually pre-compressed fiber prior to mechanical press compression;

FIG. 20 shows a non-limiting example of a batch press;

FIGS. 21 and 22 show non-limiting examples of hydroponic substrate layers prepared on the batch press;

FIG. 23 shows a non-limiting example of a continuous press; and

FIGS. 24A and 24B show additional non-limiting examples of layered hydroponic substrate slabs according to one or more embodiments disclosed herein in a hydroponic system including irrigation devices and grow cubes with plants, the slabs being enclosed in non-limiting example wrappings cut to enable view of the layers;

FIG. 25 shows a non-limiting example of a layered hydroponic substrate slab according to one or more embodiments disclosed herein in a hydroponic system including irrigation devices and a grow cube with a plant, the slab being enclosed in a non-limiting example wrapping and having openings for the grow cube and drip stakes;

FIG. 26A shows a non-limiting example of a layered hydroponic substrate, in the dry state, structured as a grow cube with a number of indentations arranged to accommodate a seedling and drip stakes;

FIG. 26B shows the grow cube of FIG. 26B with a wrapping enclosing the grow cube;

FIG. 26C shows the grow cube of FIGS. 26A and 26B in use, in the hydrated state;

FIG. 27A shows a set of samples having 1-6 layers of the hydroponic substrate disclosed herein in a dry state;

FIG. 27B shows the samples of FIG. 27A in a hydrated expanded state;

FIG. 28A shows a comparison of a multi-layer hydroponic substrate disclosed herein in a hydrated state without a wrapping and a coir substrate without a wrapping after 7 days of providing hydration;

FIG. 28B is a close-up of the hydroponic substrate of FIG. 28A with discernable crusts and inner material hydration differences;

FIGS. 29A and 29B are photographs of a water distribution test of examples A1-A3, hydroponics substrate compressed with heat, comparative examples b1-b3, substrate compressed without heat, and comparative examples c1-c3, hand-packed substrate with no heat application at initial hydration and after 12 hours;

FIG. 30 is a close-up view of example A3 from FIGS. 29A and 29B at initial wet out before the moisture reached a bottom layer;

FIG. 31A is a prior-art rockwool substrate with plant root growth developed in the substrate while wrapped;

FIG. 31B is a herein-disclosed hydroponic substrate with plant root growth developed in the substrate while wrapped;

FIG. 31C is a herein-disclosed hydroponic substrate with plant root growth developed while under a row cover;

FIG. 31D is a loose fiber substrate with plant root growth developed in the substrate while wrapped;

FIG. 32 is a photograph of a float test of examples D1-D3, a substrate compressed according to one or more embodiments disclosed herein at a moisture content value, and comparative examples e1-e3, loose fiber at the same moisture content value as examples D1-D3;

FIG. 33 shows a non-limiting example of the hydroponic substrate disclosed herein structured as a single layer microgreens mat in the hydrated state;

FIG. 34 shows a non-limiting example of the hydroponic substrate disclosed herein structured as a grow cube free of a wrapping with a tomato plant;

FIG. 35 shows discreet layers of the hydroponic substrate disclosed herein in a dry state and the hydroponic substrate disclosed herein in hydrated state;

FIG. 36 a non-limiting example of a hydroponic substrate disclosed herein including a plurality of stacked layers secured with a dissolvable tie;

FIGS. 37A and 37B are microscopic images of fibers and pore gaps between the fibers of an inner portion of a substrate disclosed herein in the dry state and hydrated state, respectively;

FIGS. 38A and 38B are microscopic images of fibers and pore gaps between the fibers of a crust or densified portion of a substrate disclosed herein in the dry state and hydrated state, respectively;

FIG. 39A is a photograph of a non-limiting example compressed substrate layer including wood fiber as disclosed herein, the darker hue representing a dye demonstrating wicking capability of the substrate structure; and

FIG. 39B is a photograph of loose wood fiber packed into a container; the darker hue representing a dye demonstrating wicking limitations of the loose fiber material.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Unless stated otherwise, the wt. % is based on the total weight of the substrate and the vol. % is based on the total volume of the substrate.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . , 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps. The term “including” or “includes” may encompass the phrases “comprise,” “consist of,” or “essentially consist of.”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Hydroponics, or soilless horticulture dates back to at least the 17^{th} century. At that time, the exploration of the solution hydroponics, or growing terrestrial plants without any substrate or inert medium contributed to understanding of essential elements and conditions for plant growth. While hydroponics gained its name due to plant growth in water, the term also encompasses cultivation of terrestrial plants in a substrate different from water as long as the substrate is free from soil. Nonlimiting example substrates include an expanded clay aggregate, growstones, coir or coco peat, rice husks, perlite, vermiculite, pumice, sheep wool, rock or mineral wool, brick shards, polystyrene packing peanuts, among other types.

In comparison with growing methods in soil, hydroponics presents several advantages. For example, the roots of the grown plants may have better access to the beneficial amount of oxygen, nutrients, and water than plants grown in soil. Additionally, as soils around the globe are becoming more and more depleted by modern agricultural and farming techniques, fruits and vegetables are becoming less nutritious as a result. This is especially problematic as the long-term sustainability goal is to reduce the meat consumption and reorient the world populations on having primarily plant-based diets. Furthermore, additional nutrient loss may occur due to transportation of fruits and vegetables over long distances before they reach a consumer. It is estimated that most produce may lose at least a portion of their nutrients within 24 hours of harvesting. Therefore, social movements such as farm-to-table with focus on maximizing utilization of locally grown fruits, vegetables, and herbs within communities are picking up momentum. To achieve the sustainability goals, the fruits and vegetables will need to be grown to provide majority of nutrients a human body needs for sustenance and nourishment, and they may need to be grown locally. Hydroponic growing, which provides nutrients to the roots in a more accessible way than soil-growing, may have increased capability to produce more nutritious foods. Additionally, the nutritious produce may be grown hydroponically where soil-based agriculture may not be feasible due to climate, terrain, and/or other conditions.

Yet, certain hydroponic substrates which are being used have a variety of disadvantages. For example, manmade materials such as polystyrene may release styrene absorbable into plants and their fruit, which may present a health risk to the plant consumer. Other substrates such as brick shards may cause alteration of desirable pH. Other substrates may negatively affect hormones which regulate plant growth. Substrates such as peat may harden and become too dense with time.

Additionally, traditional peat harvesting has undergone more recent scrutiny as a potential environmental concern with harvested, unrehabilitated peat bogs contributing to released carbon dioxide, otherwise stored in the undisturbed bogs. Traditional peat harvesting is thus unsustainable and in some regions restricted.

One of the most commercially utilized hydroponic substrates has been rockwool. Rockwool, also known as mineral wool, is an inert substrate made from molten rock such as basalt and sand that is spun into bundles of single filament fibers. The fibers are bonded into a medium capable of capillary action. Rockwool growing media may be used in the form of slabs or cubes wrapped in a plastic packaging with several openings for drainage. The hydroponic fluid is fed to the top surface of the substrate and becomes available to the plants' root system as it percolates via the substrate due to gravitational forces. One of the disadvantages of the rockwool material is mechanical irritation of skin and lungs of a person handling the material, for example during manufacture or use. Another disadvantage is environmental burden as rockwool is very difficult to dispose of. Practically, after being used, the rockwool slabs may be buried, but rockwool does not decompose, and thus becomes an environmental burden. Additionally, rockwool has a high pH requiring adjustment of the hydroponic solution to arrive at a neutral pH in the zone of the root system. An overall maintenance of pH of the rockwool slabs is required as rockwool is subject to pH shifts. Additionally still, rockwool, due to its high water holding capacity (WHC), is susceptible to development and retention of plant diseases.

Another material used for hydroponics has been coco coir. Coco coir has disadvantages such as lack of sterility, potential presence and import of pathogens, high salt content, and water contamination during production via buffering leachate which poses environmental issues. Additionally, coir slab quality may decrease relatively fast in storage, increasing problems with rewetting.

Thus, there is a need for a hydroponic material overcoming one or more of the above-mentioned disadvantages.

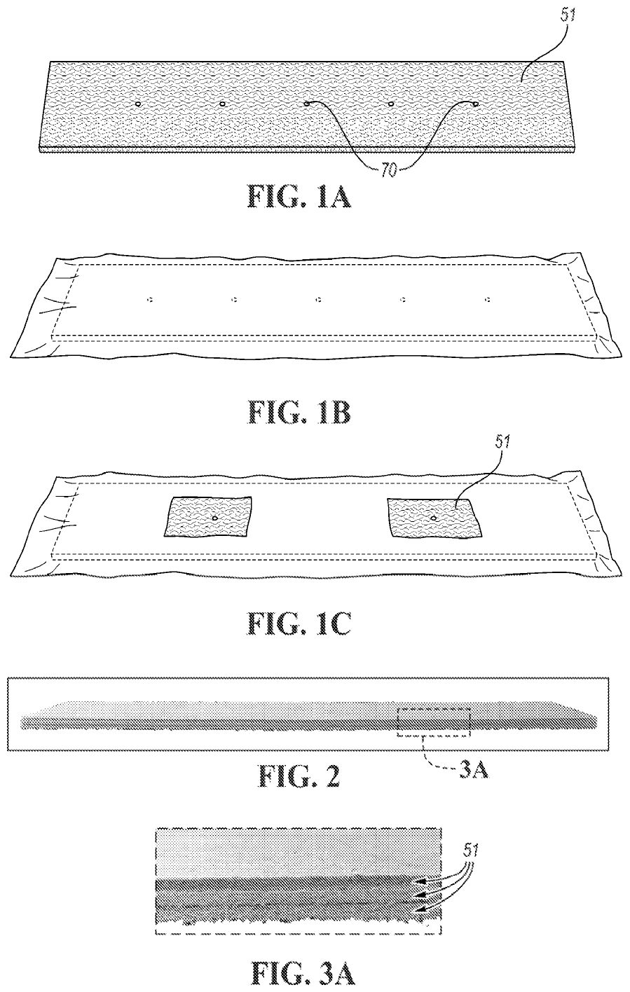

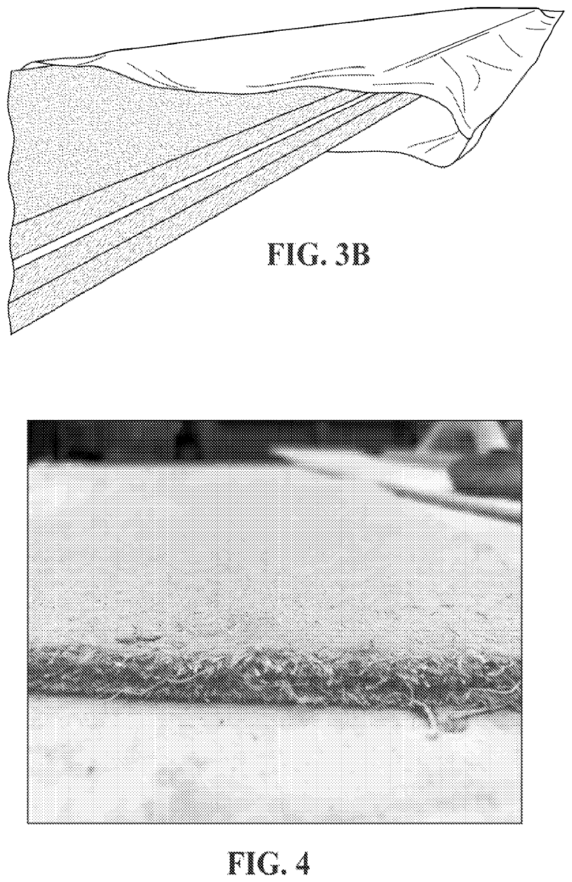

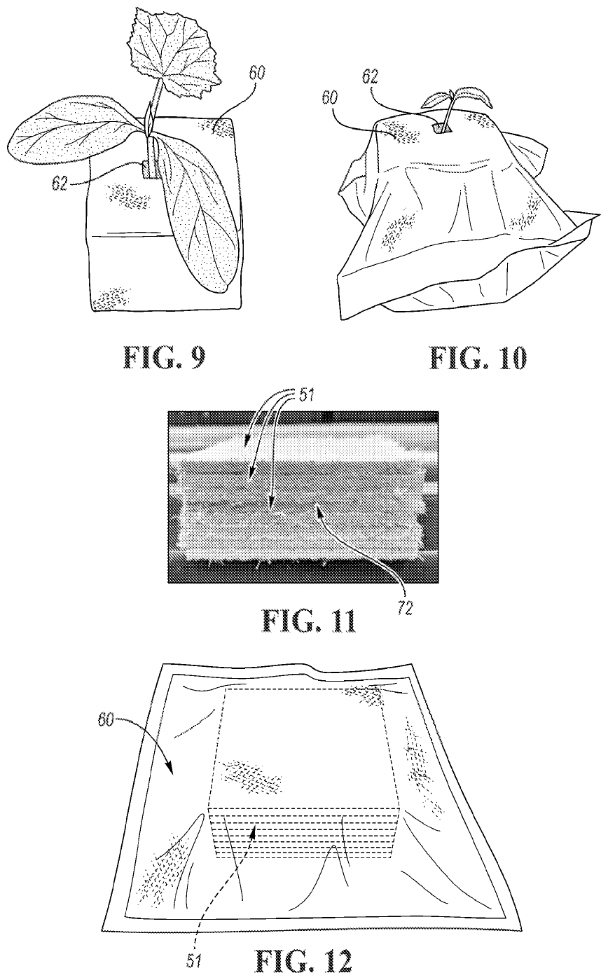

In one or more embodiment, a hydroponic substate is disclosed. The hydroponic substate may be a three-dimensional (3D) layered product. The hydroponic substate may be a slab, block, cube, mat, or have another shape suitable for hydroponic growing and convenient for transportation to a distributor or consumer. The substrate may be a self-supporting structure. The self-supporting substrate may be understood to be a self-supporting vertically and horizontally substantially stable structure having a dry state and a hydrated state during which the substrate expands with substantially even, flat expansion of the top layer, resulting in particularly desirable growing properties for grow cube placement, seedling start, and plant growth. At the same time, the substrate may be sterile, biodegradable, and sustainable. The substrate may be configured to have water distribution substantially throughout the entire volume of the substrate due to the presence of lateral water pathways and vertical water pathways. The substrate may be rewettable without a surfactant. One or more of the properties named herein and below solves one or more problems, and provides a technical solution to one or more problems, associated with prior art hydroponic substrates. Non-limiting examples of the hydroponic substrate disclosed herein are shown in FIGS. 1-13C, 24A, 24B, 26A-27B, 31B, 31C, and 33-36.

The hydroponic substrate may have two different states. The first state may be a dry compressed state, referring to a state after compression and before hydration. The initial material is pressed into a compressed hydroponic substrate having a predetermined shape and properties and moisture content of less than about 20%. The initial material is pressed into a compressed hydroponic substrate, the substrate having a predetermined shape and properties and moisture content of about 10% by weight lower than the initial material. Such state is a first or dry state and defines the substrate after production, during storage, during transport, and/or during sale. The dry state is shown for example in FIGS. 1A-6, 11, 12, 21, 22, 26A, 26B, and 27A.

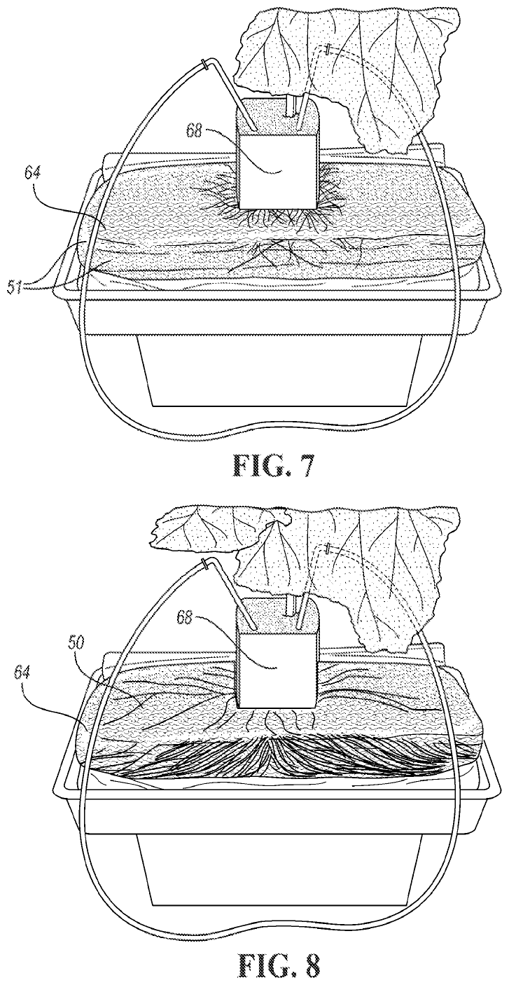

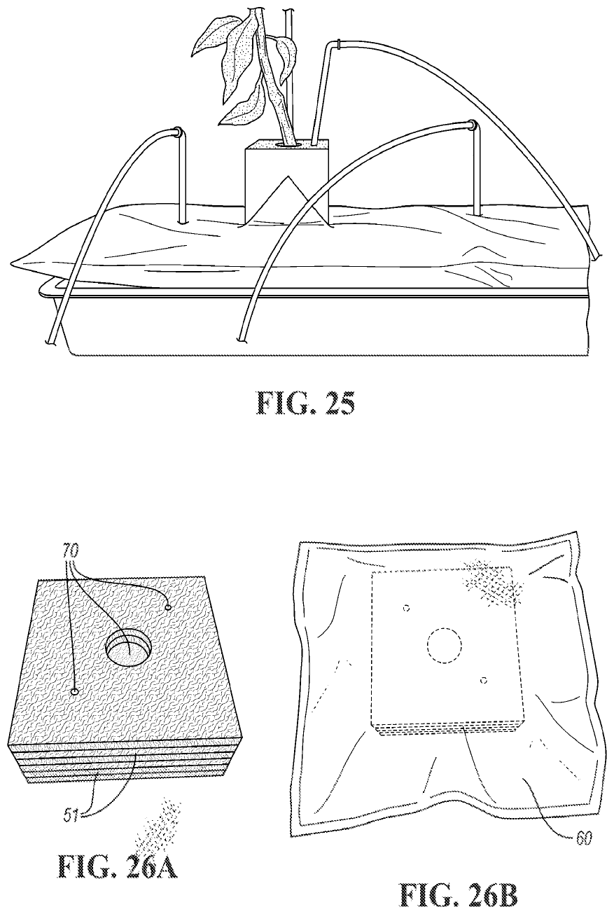

The second state may be called hydrated or saturated state, referring to a state after compression and after hydration. Hydration relates to a sufficient amount of moisture to cause an increase in the substrate's moisture content above 20% by weight, after the amount of moisture is introduced to the substrate. The second state may be after sale, after set up in a growing operation, after the substrate is put in contact with a seed or plant, after initial wet out, after first irrigation, etc. The second state may also be called hydrated expanded state as the added moisture may cause expansion or swell or increase in at least one dimension such as thickness/height of the substrate. The hydrated state is shown for example in FIGS. 7-10, 13A-13C, 24A, 24B, 25, and 26C, 27B-30, 31B, 31C, 33, 34, and 39A.

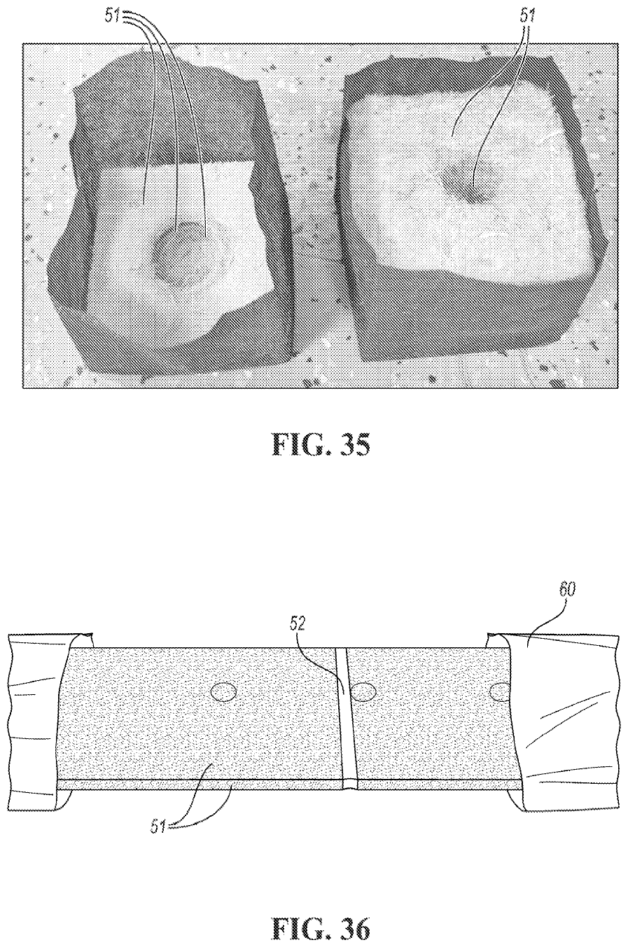

Both the dry and hydrated states are shown in FIG. 35, which depicts discreet layers of the substrate in the dry state in a non-limiting example wrapping on the left and hydrated layers of the substrate within a non-limiting example wrapping in the hydrated state on the right. Both sets of layers include a hole in a central portion of the substrate.

The hydroponic substrate disclosed herein may have a distinct advantage in comparison to other hydroponic media related to the hydrated state. The hydroponic substrate is structured to hydrate within a very short period of time compared to other hydroponic media. The hydroponic substrate disclosed herein may hydrate and expand substantially instantly after contact with water. The hydroponic substrate may hydrate and expand within 5-60, 20-50, or 30-40 minutes after water is introduced onto the substrate. The greatest expansion may occur within 30-360 seconds after introduction of water onto the substrate. For example, a hydroponic substrate configured as a slab in a wrapping may start hydrating within about 30 seconds after water is introduced into the wrapping and be fully hydrated and expanded within an hour from the initial introduction of water onto the substrate. Once initiated, the expansion may continue even after the substrate's moisture content gets lower or as the substrate loses water. The substrate may undergo a continued expansion as it loses water weight.

Additionally, the relatively rapid expansion may result in an even, uniform expansion. A uniform expansion throughout the substrate is beneficial for growing purposes due to a substantially even, level surface suitable for installation of grow cubes or input of plant material. Additionally, an even expansion may provide suitable conditions for irrigation as the even expansion may contribute to even expansion of water pathways. The expanded substrate may be free of uneven surfaces, dry spots, non-uniform surfaces. The hydroponic substrate disclosed herein does not require an addition of a surfactant to hydrate and expand evenly. The substrate hydrates and rewetts without a surfactant. The hydroponic substrate disclosed herein may be free of a surfactant. The substrate may be thus fully organic, sustainable, free of non-renewable materials.

In sharp contrast, other hydroponic media such as rockwool require an extended time period to hydrate. The extended time period may be about 12 hours, 24 hours, or more. Moreover, materials such as rockwool require use of surfactants to assist with the hydration. Without the surfactants, the expansion may take longer than 24 hours and dry spots, non-uniform surface may occur.

In a non-limiting example, the hydroponic substate disclosed herein may include a number of layers, stacked on top of one another, forming the body of the substrate. Each layer may have the same or different composition, properties, or both. A non-limiting number of stacked layers may be about 2-15, 3-10, or 4-8. A non-limiting number of stacked layers may be 2, 3, 4, 5, 6, 7, 8, 9, 10, 11, 12, 13, 14, 15, 16, 17, 18, 19, 20, 21, 22, 23, 24, 25, 26, 27, 28, 29, 30, or more, and any range selecting any two numbers herein. In a non-limiting example, the hydroponic substrate may have 7 to 8 layers. The layers may be independently the same or different. The layers 51 may be discernable in the dry state, as is shown for example in FIGS. 2, 3A, 3B, 6, 11, 26A, 27A, and 35. The layers 51 may be discernable in the hydrated state, as if shown for example in FIGS. 7, 8, 13A-13C, 24A, 27B-30, and 34. The layers may be visibly discernable in both states. Alternatively, in the hydrated state, the individual layers may somewhat intertwine and/or the borders of the individual layers may not be clearly discernable.

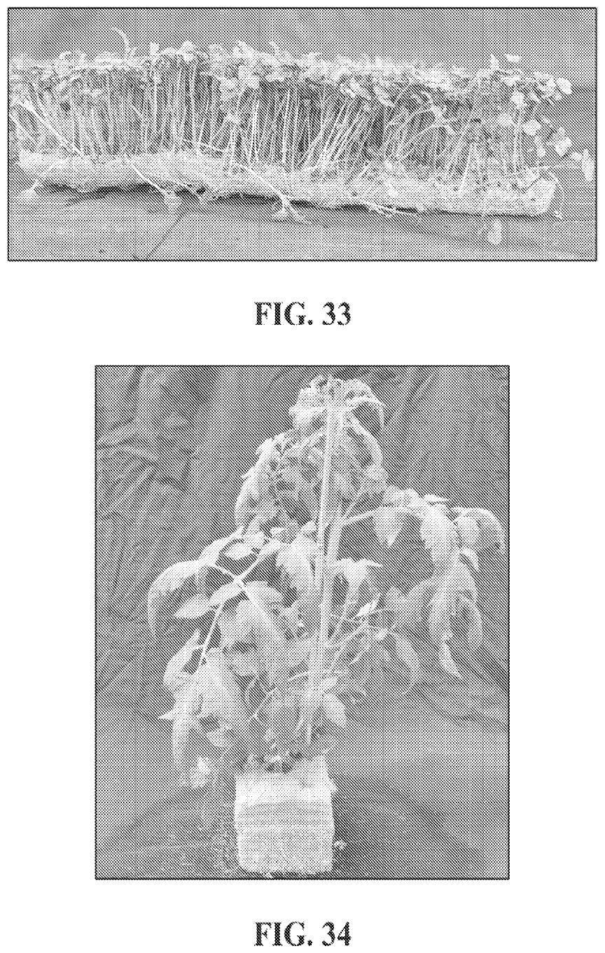

In it contemplated that a single layer may be used as a hydroponic substrate given that the layer is produced to have beneficial properties disclosed herein. A single layer having a crust on top and bottom is contemplated. The single layer may form the body of the substrate. The single layer substrate may be suitable for microgreens production, for example, as is shown in FIG. 33. The crust of the single layer may provide a benefit of lateral/horizontal water distribution in addition to vertical water movement due to gravitational forces. Additionally, the crust may provide a structural support to the growing microgreens.

Yet, unlike prior art media including organic or natural materials, the herein-disclosed substrate may retain structural integrity and stability even in a hydrated form. The substrate is thus a hydratable substrate which remains to be self-supporting after hydration. In other words, the substrate retains vertical and horizontal stability in the dry state and in the hydrated state. Stability relates to having and retaining substantially the same shape, the body of the substrate resisting disintegration while supporting its own weight.

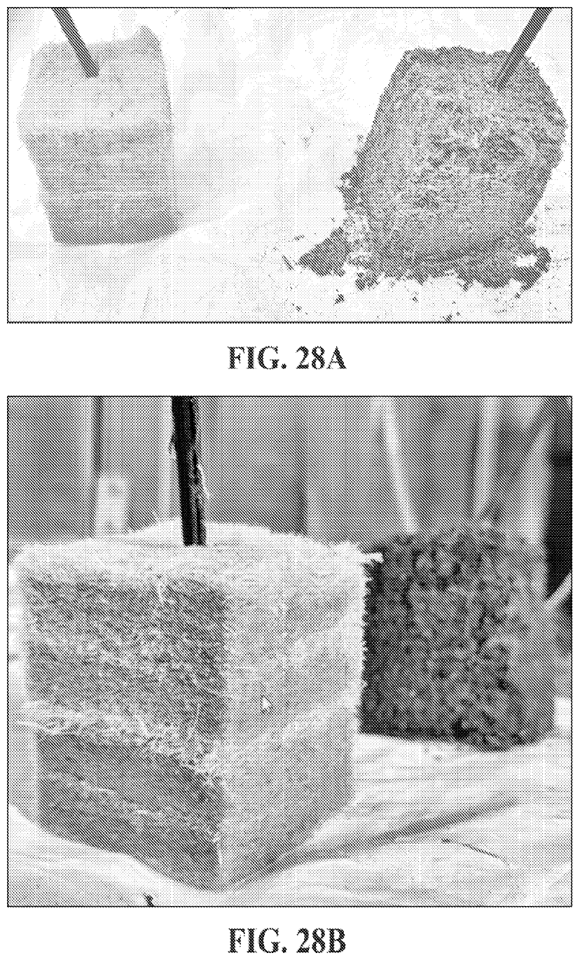

In contrast, prior art organic materials such as coco coir slabs fall apart after hydration, not having structural stability without additional support articles such as a plastic sheet or enclosure. Stability of the herein-disclosed substrate is discussed in more detail below and demonstrated in a test depicted in FIGS. 28A and 28B. In FIGS. 28A and 28B, a multi-layer substrate disclosed herein is shown on the left and a coco coir single layer block is shown on the right. Both the depicted substrates were irrigated with the same amount of water via drip irrigation device for 7 days. As can be observed, the substrate on the left demonstrates stability and negligible or no disintegration of its structure. The block on the right is leaning, a side is crumbling, and parts of its have fallen off, the entire structure of the coir block is disintegrating, and structural integrity is compromised. In a greenhouse setting, a substrate needs to have stability for the length of the growing season, that is up to about 3-6 months. The substrate disclosed herein has demonstrated acceptable vertical stability for at least 6 months. The coir substrate with no covering did not and it would crumble entirely within a few weeks.

Each layer, or at least some of them, may include a crust. The crust is a tougher, denser, more rigid and less porous outer part of the layer. The crust may be included on the top of the layer, bottom of the layer, one or more sides of the layer, or a combination thereof. In a non-limiting example, a layer may include a top and bottom crusts and have four side portions essentially free of a crust. The crust may include partially melted fibers, entangled fibers, or both. The crust may include fibrous material having a higher density, higher rigidity, higher toughness, or a combination thereof, than the remainder of the layer. The crust may include fibers which have released one or more types of binders, the binders connecting, linking, and/or bonding the fibers within the crust to one another, the inner material, or both.

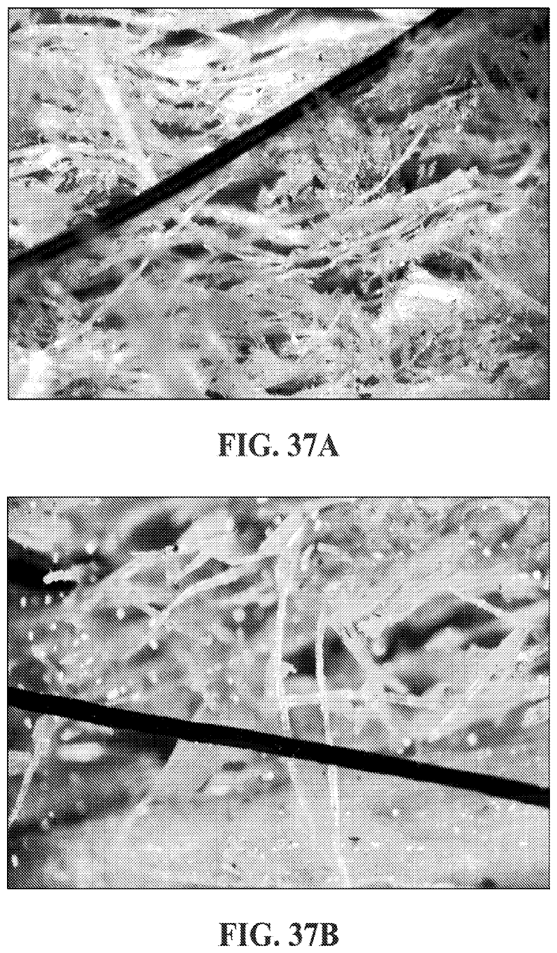

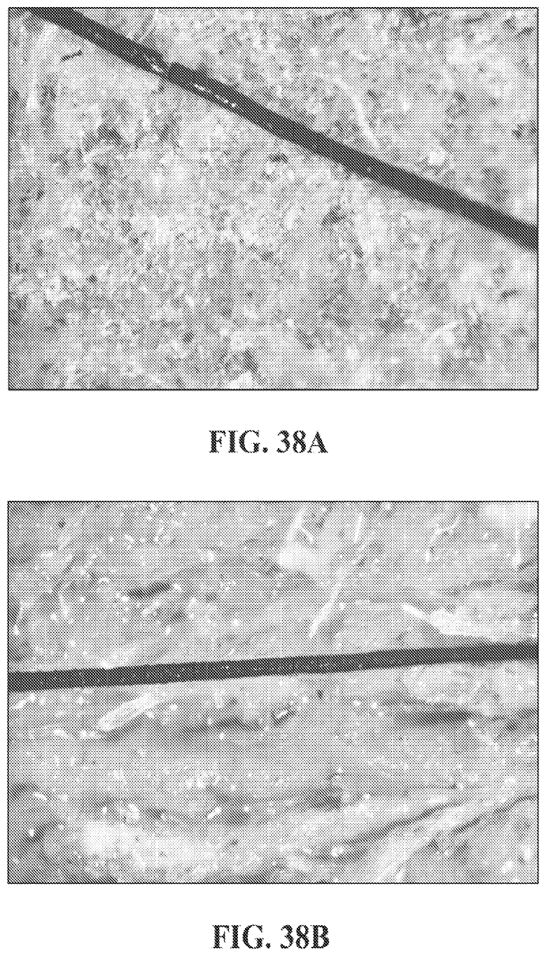

The densified crust may include smaller pores than the inner material as at least a significant portion of the large pores may have been removed or eliminated by formation of the crust. An average pore size of the densified fiber of the crust may be smaller than an average pore size of the inner portion material. In other words, the outer crust has less porosity than a corresponding area of the inner portion. FIGS. 37A-38B demonstrate the pore size differences between the crust and inner portion. FIG. 37 shows the fibers and pore sizes between the individual fibers in the inner portion of the substrate disclosed herein in the dry state. The gaps between the fibers are discernable. FIG. 37B shows the same inner portion in the hydrated state. Pore gaps are likewise visible. FIG. 38A shows fibers and pore sizes between the individual fibers in the crust or densified portion of the substrate disclosed herein in the dry state. FIG. 38B shows the same crust in the hydrated state. As can be seen, the pore size shown in FIGS. 38A and 38B is considerably smaller than pore sizes in FIGS. 37A and B. In all four images, 37A-38B, a single black coir fiber is provided for size comparison, measuring at 0.09 mm in diameter. In other words, the crust has lower porosity than the inner portion, the pores having a smaller surface area in the crust than in the inner portion.

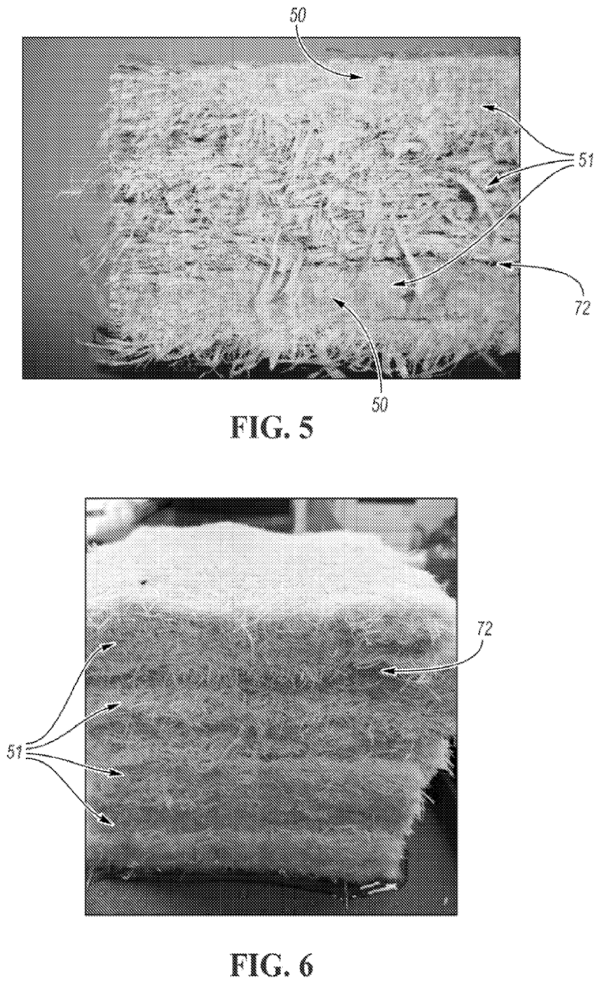

The densified fiber of a crust 50 can be seen on top of the sample layers in FIGS. 5, 8, 28A, and 28B. In contrast, FIG. 6 includes layers with no crust. The densified fiber may have a fiber density which is different and/or greater than the fiber density of the inner portion. The densified fiber may have about 5-200, 10-180, or 50-150% greater density than an inner material. The densified fiber may have about 5, 10, 20, 30, 40, 50, 60, 70, 80, 90, 100, 110, 120, 130, 140, 150, 160, 170, 180, 190, or 200% greater density than an inner material.

The total crust amount, whether the layer has one or more crusts, may be about, at most about, or at least about 80, 75, 70, 65, or 60% of the layer thickens. The crust may be about 1-80, 10-70, 20-60, or 30-50% of the layer thickens. The crust may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80% of the layer thickens. The values are relevant to the dry state, hydrated state, or both.

The total crust, whether the layer has one or more crusts, may be about, at least about, or at most about 90, 85, 80, 75, 70, 65, or 60% of the substrate weight in the dry compressed state, define below. The crust may be about 5-90, 60-80, or 65-75% of the layer weight. The crust may be about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% of the layer weight.

A single crust may be about, at least, or at most about 40% of the layer weight in the dry compressed state. The single crust may be about 20-50, 25-45, or 30-40% of the layer weight. The single crust may be about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% of the layer weight.

The values are relevant to the dry state, hydrated state, or both. Non-limiting example of the crust properties are shown in the Table 1 below.

TABLE 1
Non-limiting example crust properties in dry compressed state

| Layer | Weight | Thickness | Density |
|---|---|---|---|
| Description | [g] | [mm] | [lb/ft³/kg/m³] |
| 1 layer sample | 15.08 | 0.50 | 32.6/522.2 |
| Top crust | 4.05 | 0.13 | 33.7/539.8 |
| Bottom crust | 6.57 | 0.17 | 44.8/717.6 |
| Fiber between the top | 4.19 | 0.21 | 22.1/354.0 |
| and bottom crusts | | | |

The substrate may have a first fiber density and a second fiber density. The first fiber density relates to the inner material or inner portion density. The second fiber density relates to the crust or densified portion density.

The crust density may be about 25-80, 30-70, or 35-65 lbs/ft³ or 400-1281, 480-1121, or 560-1040 kg/m³. The crust density may be about 25, 30, 35, 40, 45, 50, 55, 60, 65, 70, 75, or 80 lbs/ft³. The crust density may be about 400, 450, 500, 550, 600, 650, 700, 750, 800, 850, 900, 950, 1000, 1050, 1100, 1150, 1200, 1250, or 1281 kg/m³.

The inner material density may be about 10-30, 12-28, or 15-25 lbs/ft³ or 160-480, 192-448, or 240-400 kg/m³. The inner material density may be about 10, 11, 12, 13, 14, 15, 16, 17, 18, 19, 20, 21, 22, 23, 24, 25, 26, 27, 28, 29, or 30 lbs/ft³ or 160, 180, 200, 220, 240, 260, 280, 300, 320, 340, 360, 380, 400, 420, 440, 460, or 480 kg/m³.

A ratio of the inner material density:crust density may be about 1:2.5-3:8, 1.2:3-2.8:7, or 1.5:3.5-2.5:6.5. The ratio of the inner material density:crust density may be about 1:8-2.4:2.5, 1.2:7-2.8:3, or 1.5:6.5-2.5:3.5. The ratio of the inner material density:crust density may be about 0.17-0.95, 0.23-0.45, or 0.3-0.4. The ratio may be about, at least about, or at most about 0.1, 0.15, 1.2, 0.25, 0.3, 0.35, 0.4, 0.45, 0.5, 0.55, 0.6, 0.65, 0.7, 0.75, 0.8, 0.85, 0.9, or 0.95.

The crust fiber density may be about, at least about, or at most about 1-20, 1.4-15, or 2-8% higher than the inner material density. The crust fiber density may be about, at least about, or at most about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20% higher than the inner material density.

The overall density of the substrate material, an average of the crust and inner material density, may be about 30-50, 32-48, or 35-45 lbs/ft³. The overall density may be about, at least about, or at most about 30, 31, 32, 33, 34, 35, 36, 37, 38, 39, 40, 41, 42, 43, 44, 45, 46, 47, 48, 49, or 50 lbs/ft³. The overall density may be about 1.87-3.12, 1.99-2.99, or 2.18-2.81 kg/m³. The overall density may be about, at least about, or at most about 1.87, 1.88, 1.89, 1.90, 1.91, 1.92, 1.93, 1.94, 1.95, 0.96, 1.97, 1.98, 1.99, 2.0, 2.02, 2.04, 2.06, 2.08, 2.10, 2.12, 2.14, 2.16, 2.18, 2.20, 2.22, 2.24, 2.26, 2.28, 2.30, 2.32, 2.34, 2.36, 2.38, 2.40, 2.42, 2.44, 2.46, 2.48, 2.50, 2.52, 2.54, 2.56, 2.58, 2.60, 2.62, 2.64, 2.68, 2.70, 2.72, 2.74, 2.76, 2.78, 2.80, 2.81, 2.82, 2.84, 2.86, 2.88, 2.90, 2.92, 2.94, 2.96, 2.98, 2.99, 3.00, 3.02, 3.04, 3.06, 3.08, 3.10, or 3.12 kg/m³.

Without limiting the disclosure to a single theory, it is believed that the layering, the presence of crust and inner material, or a combination thereof may contribute to beneficial properties of the substrate. For example, water distribution within the hydroponic substrate including one or more layers having at least one crust may be improved in comparison to a compressed substrate, especially one without multiple layers and/or without a crust. Variation in density associated with the layering and/or crust may contribute to better water distribution in the substrate. For example, in a substrate without a crust, the water, by gravity, percolates through the substrate's top and central layers to the bottom layer. The water may thus accumulate primarily at the bottom of the substrate. This is especially true when drip irrigation is used. A drip irrigation system includes a drip article such as a drip stake which is installed in one location within a growth substrate. In a case of a slab, two or at most three drip stakes may be installed. The drip stakes remain in the same location, distributing water with nutrients from the same location repeatedly. Due to the gravitational forces and structure of the traditional media, water percolates to the bottom of the substrate or slab. That leaves areas such as one or more sides and/or the upper surface dry or having a lack of moisture. Only a portion of a traditional slab is thus hydrated and capable of sustaining and supporting growth of roots and plants. Remainder of such substrate thus remains unutilized.

In a traditional substrate, since plant roots follow water, once a plant is placed on/in top of the substrate, the plant roots may directly aim downward towards the bottom layer having the largest water content. This may leave a large volume of the substrate underutilized by the root system, which is limited to the bottom portion of the substate.

In contrast, a substrate having the layers and/or crusts, as disclosed herein, features portions with a higher density than other portions of the substrate. The densified portions have tighter pore gaps or less porosity. Since water follows the path of least resistance, the densified portions lead water differently than portions with lower density, causing the water to find substantially lateral (left and right) pathways. Additionally, a gap/space between two layers, discussed below, may also contribute to the substantially lateral water flow and creation of lateral/horizontal water pathways. This in turn influences where the roots of a plant may want to grow. In the substrate having the layers and/or crusts, the plant roots will follow the lateral as well as the vertical paths the water may take. As a result, a larger volume of the substrate is utilized for growth of the plant than in traditional substrates, the root system may become more robust, and the plant may have increased growth and/or yield.

Since in hydroponics substantially all the nutrients are provided via the liquid or aqueous solution, the ability to provide nutrients throughout the volume of the substrate translates into the ability to grow the plant throughout a higher percentage of the substrate. The herein-disclosed substrate thus solves a problem of using the entire or substantially large volume of the substrate for growth because the herein-disclosed substrate's structure is configured to provide moisture throughout its volume effectively.

Furthermore, roots grow in an area with moisture. If that area is constrained, a plant's ability to develop big enough rootzones or root ball can be limited. In turn, the roots can become crowded and the plant may not receive sufficient nutrients. The resulting plant may be smaller and have smaller yields than if the optimal area for root growth was larger. Since the herein-disclosed substrate provides the lateral water pathways, the area for plant root growth is relatively increased or maximized.

The crust, densified portions, and/or gap space between layers may thus form water disruption pathways or substantially lateral water path formations which are beneficial to plant growth. Additionally, due to pore size or porosity differences between the crust and the inner portions, the crust areas, relative to the inner portions, may be areas of higher oxygen capacity and the inner portions may be areas with greater water capacity, providing sufficient oxygen as well as water throughout the volume of the substrate.

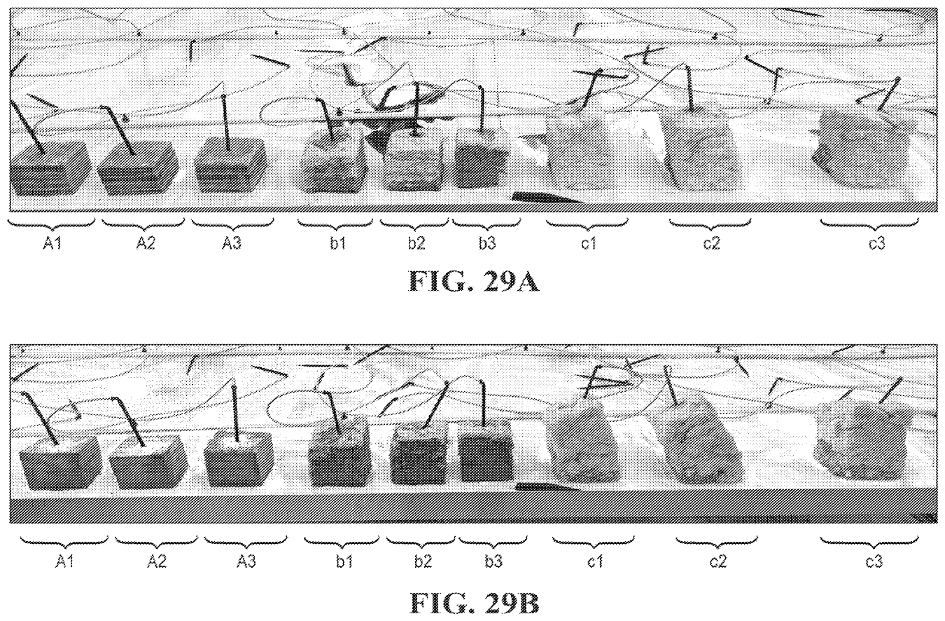

FIGS. 29A and 29B show the effect of the herein-disclosed substrate's structure on water/nutrient liquid distribution. Both figures depict three sets of substrates, each having the same composition and including 140 g of the wood fiber. The examples A1-A3 are multi-layer substrate examples with 4 layers each, compressed with pressure and heat, thus acquiring top and bottom crusts on each layer. The comparative examples b1-b3 are multi-layer substrate samples with 4 layers each, compressed with pressure but no heat, thus lacking the crusts. The comparative examples c1-c3 are a single layer loose material placed in a container 10×10 cm, pressed by hand and pushed out of the container. Comparative examples c1-c3 have no crust or organized multi-layer structure.

All examples A1-A3 and comparative examples b1-b3 and c1-c3 were each provided with an irrigation stake and irrigated with water containing blue marking dye. The examples and comparative examples were all provided with the same volume of water at the same drip rate. FIG. 29A shows the examples and comparative examples after initial hydration. As can be observed, examples A1-A3 show water distribution not only vertically, but horizontally or laterally. The water in examples A1-A3 progressed layer by layer, spreading laterally, then horizontally, then laterally again, etc. thus hydrating each portion of the entire substrate.

In contrast, the crust-free comparative examples b1-b3 hydrated predominantly in a vertical manner. Water followed the path of least resistance. As a result, some sides of the substrate b1-b3 were saturated while other sides and the top layer remain mostly dry. This effect is even more visible in the comparative examples c1-c3, where the water moved rapidly in a vertical way, resulting in a pooling in the bottom layer. The pooling may be observed with comparative examples b1-b3 and c1-c3 with the dye leaking out of the comparative examples onto the white tarp.

The same examples A1-A3 and comparative examples b1-b3 and c1-c3 are shown 12 hours after the initial hydration in FIG. 29B. Examples A1-A3 show full saturation with moisture well-distributed throughout the volume of the examples. Comparative examples b1-b3 show saturation of one or more sides with two or more sides and the top layer lacking moisture. Comparative examples c1-c3 lack moisture distribution throughout most of its volume, with water accumulation in the bottom layer. While the substrate of examples A1-A3 is evenly and thoroughly moistened and features even saturation throughout due to the presence of lateral and horizontal water pathways, comparative examples b1-b3 and c1-c3 feature channeling of the liquid towards the bottom of the substrate, thus not providing water to the entire volume of the substrate.

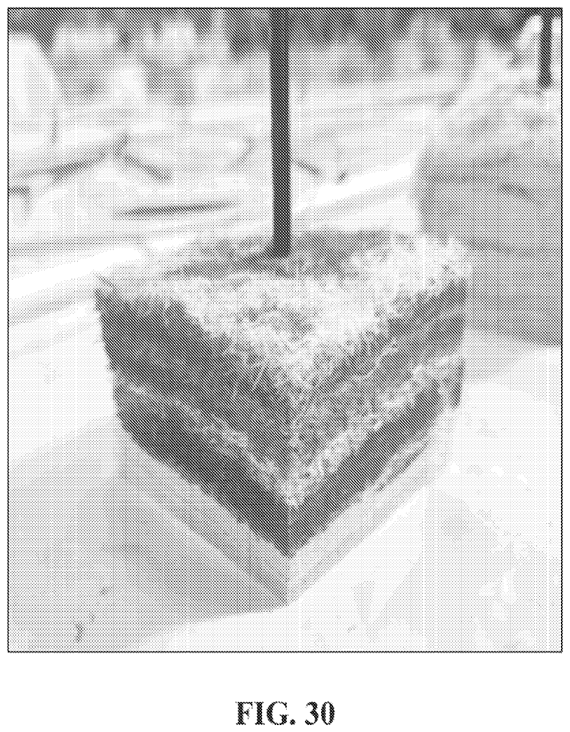

To further demonstrate the presence of lateral water pathways in the crust-including substrate disclosed herein, FIG. 30 shows the example A3 after the initial application of moisture. As can be observed in FIG. 30, the water with the dye spread laterally first before it reached the bottom layer, which was captured dye-free while the top layers were colored with the dye, thus indicating presence of moisture.

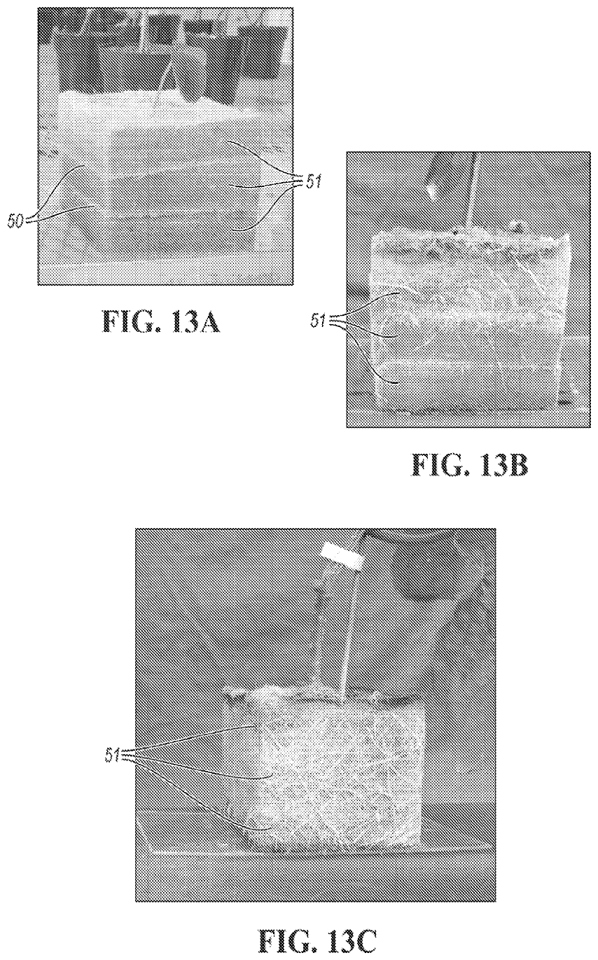

The effect of the crusts on a layered substrate disclosed herein can be further seen in FIGS. 7 and 8. As the FIGS. 7 and 8 show, the plant roots started in a grow cube, which was placed on top of the herein-disclosed slab. The roots have spread laterally as well as vertically throughout the substrate, thus utilizing the entire volume of the substrate, forming a robust root system. Similar effect can be observed in an Example of FIGS. 13A-13C. A seedling was inserted in a grow cube formed as a compressed, layered hydroponic substrate disclosed herein. The cube had three layers, each containing a crust at the top and bottom. As can be seen in FIG. 13B, the seedling's roots penetrated the layers vertically and laterally as the seedling started growing, following moisture. FIG. 13C shows the seedling in a plant stage with the roots encompassing substantially the entire volume of the grow cube and covering all three layers of the substrate on all sides.

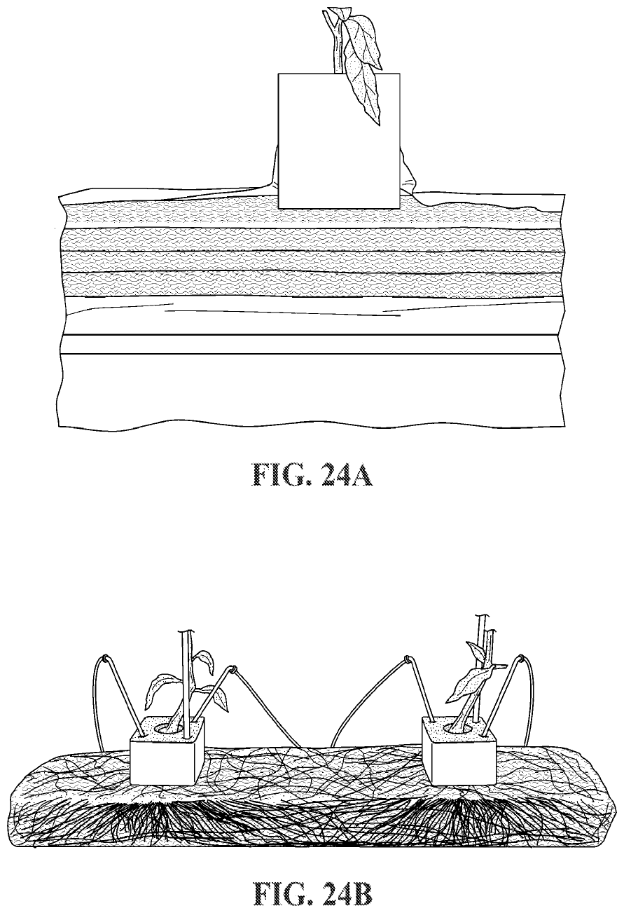

A further example of the lateral root expansion and root presence throughout the substrate volume may be observed in FIG. 24B, depicting a multi-layer slab accommodating prior art grow cubes. The root expansion is also shown in FIG. 33, depicting a microgreens mat utilizing a single layer including a crust and inner material of the substrate disclosed herein. FIG. 34 further depicts a grow cube including the multi-layer structure disclosed herein, each layer including crusts and inner material. The grow cube includes a tomato plant with an extensive root system throughout the cube. The cube also features a hole to accommodate a physical support for the tomato plant. The grow cube does not require a cover or wrapping.

The percolation principal described herein applies to water as well as other liquids and nutrient solutions including liquid fertilizers. The densified portions of the substrate with crusts may contribute to lateral distribution of liquid fertilizers to the root system. Besides the increased yield, such distribution may contribute to increased nutritional value, taste, and/or aroma of the fruits and vegetables.

Furthermore, in addition to stability after hydration, the herein-disclosed substrate is naturally rewettable. Rewettability is important for continued supply of water and nutrients to a plant grown in a substrate. Some prior art substrates such as rockwool have an acceptable initial wet-up but once the rockwool loses its initial moisture, it does not successfully rewet. In other words, additional wetting may not saturate the entire rockwool substrate after the initial wet-up. Additionally, the initial wet-up of the rockwool substrate is due to a presence of a surfactant. Yet surfactants may negatively influence plant growth. In contrast, the herein-disclosed substrate may be binder and surfactant-free and is structured to rewet numerous times, allowing for a repeated saturation of the entire volume of the substrate. Absence of a binder and surfactant also renders the medium sustainable and eco-friendly.

The hydroponic substrate may be a part of a system adapted to manage water and nutrients in hydroponic growing. The hydroponic substrate may have non-uniform or varied water distribution through its height and length. In other words, the layers and/or crust contribute to lateral and vertical liquid pathways within the substrate.

In some embodiments, the top and/or bottom portions of a layer can have embossing, texturing, and/or shorter fiber lengths to provide pre-defined additional water movement pathways.

The hydroponic system may include one or more hydroponic substrate grow cubes, hydroponic substrate slabs supporting the grow cubes, one or more irrigation devices such as drip stakes, irrigation liquid, the like, or a combination thereof. The system may be an open system or a closed system. The system may include a greenhouse setting. A non-limiting example of a portion of the system is shown in FIGS. 7, 8, 24A, 24B, 25, 26C, 31B, and 31C.

The substrate may have one or more indentations, holes, apertures, recesses, or the like which may serve for insertion of one or more drip stakes, plant growth support articles, starter plugs, and/or grow blocks. One or more layers of the substrate, such as the top layer(s), may have indentations or openings forming the substrate indentations. One or more layers may also include one or more indentations or openings to accommodate a grow block, seed, seedling, plant, the like, or a combination thereof. Alternatively, the grow blocks, seedlings, and/or plants may be positioned on top of the substrate, not requiring an indentation or opening. A non-limiting example of the indentations/openings 70 is shown in the dry state substrate layer of FIGS. 1A, 1C, 26A, 26B, 28A-30, 34, 35, and 36. The indentations may be made by drilling post press or during the pressing process by inserting an object into the fiber.

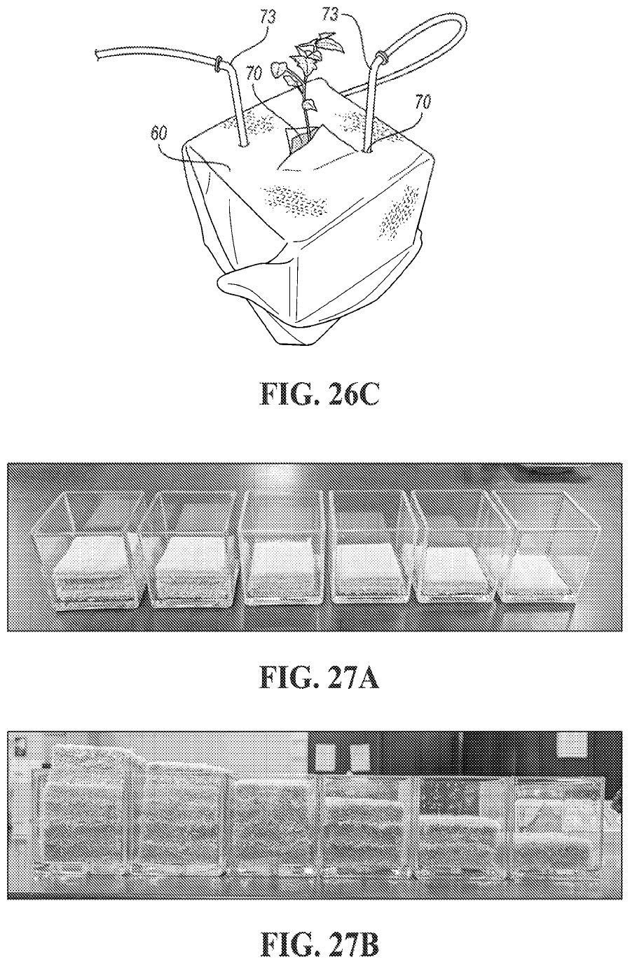

As can be seen from FIGS. 1 and 26A, the position, location, dimensions, and number of indentations may differ. In a non-limiting example of FIG. 26A, the layered substrate has two indentations 70 of a smaller diameter for drip stakes 73 and one central indentation 70 with a larger diameter structured to accommodate a seed, seedling, starter plug, or plant.

The indentations may be more than one layer thick. For example, the central indentation may be structured as a full opening through the top layers of the substrate. In a non-liming example, the central indentation may be structured as a full opening through the top 2, 3, 4, 5, 6, or 7 layers. The indentations for the drip stakes may penetrate one layer, more than one layer, all but the bottom layer, half of the layers, or the like. The openings/indentations for the drip stakes may be deeper than the central opening/indentation.

The substrate may thus have at least some first layers having one or more indentations and at least some second layers having a different number of indentations than the first layers. The substrate may also have at least some third layers having a different number of indentations than the first and second layers. The different number may be greater or smaller.

In a non-limiting example of FIG. 26A, the substrate configured as a grow cube may have two first layers having the central opening with a first diameter and additional openings with a second diameter being smaller than the first diameter. The two first layers may form top layers of the substrate. The substrate may also include up to five second layers having no central opening but having the additional openings with a second diameter being smaller than the first diameter. The second layers may form the middle layers of the substrate. The substrate may include one or more bottom layers being free of a central opening and additional openings.

Besides the crust, each layer includes inner material. The outer crust may differ from the inner material by physical, chemical, and/or mechanical properties. For example, the outer crust may have higher density than the inner material. The crust and the inner material may have the same chemical composition but differ by at least one physical and/or chemical property. It is contemplated that the outer crust may differ from the inner material by its composition as well. For example, the crust may include one or more additional materials not present in the inner material. The one or more additional crust materials may include a type of fiber. In another non-limiting example, the inner material may include one or more additional materials not included in the crust. The one or more additional inner materials may include macronutrients, micronutrients, biostimulants, fertilizers, the like, or a combination thereof.

The inner material may include larger pores than the crust. The inner material may lead water vertically, but not laterally. The inner material may be substantially free of lateral liquid pathways due to different porosity, pore quantity, pore structure, pore surface area, or a combination thereof than the crust. Relatively speaking, there are a higher percentage of substantially lateral pathways to substantially vertical pathways in the crust than in the inner material/portion.

The hydroponic substate may be compressed. The hydroponic substate includes compressed fiber. A layer, and the hydroponic substrate, include compressed material. Each layer in the substrate may be individually compressed. Alternatively, one or more layers may be compressed together. The compression may be applied via a number of processes having specific parameters to each process. For example, a layer of the hydroponic substate may be formed by the first compression process described below. Another layer may be formed by the second compression process described below.

The layered product may include some or all of the layers made by the same or different compression process. All or at least some of the layers may have been compressed to the same degree. All of the layers may also be compressed to different degrees. At least some of the layers may differ by the amount of compression applied to them during the compression process. The compression applied to the layers during formation is such that the crusts may form where desirable, as was described above. At the same time, the inner material does not densify beyond a predetermined degree so that the roots are able to penetrate the material of the layers vertically and utilize available oxygen. Overcompression and/or overdensification, which could result in low available oxygen, should be avoided. Overcompression and/or overdensification may also create layers so dense that roots may not be able to penetrate them, similar to compacted soil, leading to poor plant establishment.

The layers and/or hydroponic substate may thus have variability in at least one of the following: density, porosity, water holding capacity, moisture content, container capacity, air space, volumetric water content, thickness swell, dimensions, height, length, thickness, the like, or a combination thereof. The layers of the disclosed substrate may have independently different properties, composition, dimensions, or a combination thereof.

The hydroponic substrate may be compressed from fiber (loose fiber) layered into an initial layer height/thickness of about 0.1-100, 1-90, or 5-50 cm. The initial layer height/thickness may be also called a spreading height. The initial layer height/thickness may be about 0.1, 1, 2, 3, 4, 5, 6, 7, 8, 9, 10, 11, 12, 13, 14, 15, 16, 17, 18, 19, 20, 22, 25, 27, 30, 32, 35, 37, 40, 42, 45, 47, 50, 52, 55, 57, 60, 62, 65, 67, 70, 72, 75, 77, 80, 82, 85, 87, 90, 92, 95, 97, or 100 cm. The values in this paragraph relate to open, loose fiber before press compression. The values may encompass fiber which has been manually or otherwise pre-compressed, for example into a container which a mechanical press forms into the hydroponic substrate layer disclosed herein.

The thickness of a layer after press compression may be about, at least about, or at most about 3 mm. The thickness of a layer may be about 0.5-40, 2-10, 3-8, or 4-6 mm. The thickness of a layer may be about 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 mm. In a non-limiting example, a layer is about 6 mm thick. In another non-limiting embodiment, a layer is about 3 mm thick. Greater thickness than about 40 mm is also contemplated such that the thickness may be about 4-5 cm. The thickness of a layer may be such that the layer may have sufficient rigidity, vertical stability not to fall apart during handling. The minimum thickness may be a thickness enabling handling and transport of the layer. The values in this paragraph relate to the dry compressed state. The values in this paragraph relate to pressed fiber of a layer.

The layer or substrate disclosed herein may have rigidity or breaking force of about 20-40, 22-38, or 25-35 N/cm, measured by a test described below in the Examples section for examples 106-110 and comparative examples g1-g5. Rigidity relates to vertical and horizontal stability and the self-supporting nature of the layer or substrate disclosed herein.

After the one or more compressed layers are hydrated, the layer(s) experience swelling. In other words, the layer(s) may increase in one or more dimensions as a result of the hydration. The swelling may be even or uneven throughout the layer, substrate, or both. Preferably, the swell is even throughout the layer's length and/or volume. The swell of a layer may be about 1-300, 5-150, or 5-100 mm. The swell of a layer may be about, at most about, or at least about 300 mm. The swell of a layer may about 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, or 200, 205, 210, 215, 220, 225, 230, 235, 240, 245, 250, 255, 260, 265, 270, 275, 280, 285, 290, 295, or 300 mm. Each layer of a substrate may have the same or different value of swell. The thickness swell of a layer may be measured by the method described immediately below.

The swell thickness test method may include recording weight of a media test sample, recording thickness of the sample in the center using a thickness gauge. The sample may include three 3″×3″ square layers stacked. The method may further include placing a 10×10×10 cm (4×4×4″) square container into a water basin and filling the basin until a water depth in the container is 7 cm for the sample having the three 3″×3″ square layers stacked. The method may further include submerging the sample horizontally in the container for 10 min, removing the container with the sample inside from the water basin, and letting drain horizontally for 10 min. Using a ruler, the method may include measuring thickness of the sample in the container midway along each side and recording an average of the measured four points. Non-limiting examples of the swell test results are shown in FIGS. 27A and 27B.

The ratio of the hydrated expanded layer thickness or substrate height to the dry compressed state layer thickness or substrate height may be about, at least about, or at most about 3 or 4. The ratio may be about 1.5 to 10, 2.0 to 6.0, or 3.0 to 4.5. The ratio may be about 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 8.5, 8.6, 8.7, 8.8, 8.9, 9.0, 9.1, 9.2, 9.3, 9.4, 9.5, 9.6, 9.7, 9.8, 9.9, or 10. The overall expansion of a layer, or the substrate, may be up to about 6 or 7 times its dimensions in the dry state. Non-limiting example ratios are shown in Table 2 below for various single and multi-layer hydroponic substrates disclosed herein.

TABLE 2
Example hydrated expanded (HE) state substrate height, dry
compressed (DC) state substrate height of non-limiting
examples of single and multi-layer hydroponics substrates

| | | | | | | | | | |
|---|---|---|---|---|---|---|---|---|---|
| DC | 0.6 | 1.3 | 2 | 2.7 | 3.3 | 4 | 0.6 | 1.3 | 2 |
| height | | | | | | | | | |
| [cm] | | | | | | | | | |
| HE | 2.9 | 5.2 | 6.5 | 8.4 | 9.5 | 11.1 | 2.9 | 4.7 | 6.9 |
| height | | | | | | | | | |
| [cm] | | | | | | | | | |
| Ratio of | 4.8 | 4 | 3.5 | 3.1 | 2.9 | 2.8 | 4.8 | 3.6 | 3.45 |
| HE/DC | | | | | | | | | |
| height | | | | | | | | | |

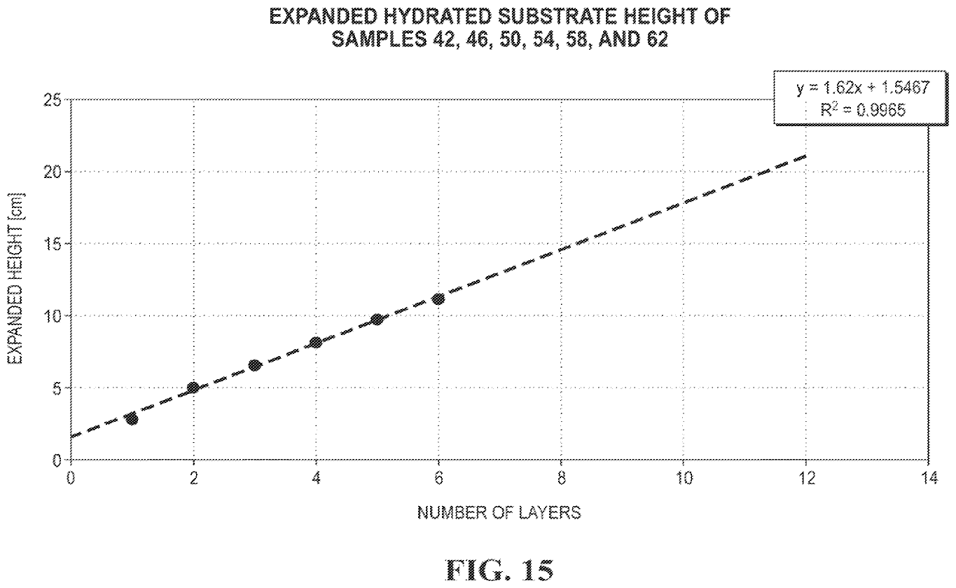

Non-limiting example hydrated expanded height for hydroponics substrates in relation to a number of layers is shown in the Table 3 below and in the plot of FIG. 15.

TABLE 3
Example expanded hydrated substrate height values
in relation to a number of substrate layers

| | Number of layers in the substrate | | | | | |
|---|---|---|---|---|---|---|
| | 1 | 2 | 3 | 4 | 5 | 6 |
| Expanded hydrated | 2.7 | 5.2 | 6.5 | 8.4 | 9.5 | 11.1 |
| substrate height | 2.9 | 5.0 | 6.5 | 8.1 | 9.7 | 11.1 |
| [cm] | 2.9 | 4.7 | 6.9 | 8.5 | 10 | 11.1 |
| | 2.5 | 4.5 | 5.8 | 7.4 | 8.7 | 10.6 |
| Average | 92% | 84% | 81% | 76% | 74% | 69% |

The overall height of the hydroponic substrate, assembled from one or more compressed layers, may be about 0.04 to 40, 1 to 20, or 4 to 10 inches or 0.1 to 100, 2.5 to 50, or 10.2 to 25.4 cm. The overall height may be about 0.04, 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, 9.75, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 inches. The overall height of the hydroponic substrate may be about 0.3, 0.4, 0.5, 0.6, 0.7, 0.8, 0.9, 1, 1.1, 1.2, 1.3, 1.4, 1.5, 1.6, 1.7, 1.8, 1.9, 2, 2.25, 2.5, 2.75, 3, 3.25, 3.5, 3.75, 4, 4.25, 4.5, 4.75, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 cm. The values in this paragraph relate to the dry compressed state, hydrated expanded state, or both.

As was stated above, it is desirable that the substrate has a uniform height through its length. Uniformity relates to up to about 0.5 inch (1.3 cm) difference in the substrate's height and having no appreciable mounds, pillow-shape protrusions, or other visible or measurable differences within its top surface.

The height in the dry state with the capability to expand to the desired height in the expanded hydrated state described herein results in transportation advantages, cost savings, and lower carbon footprint when compared to other substrates. Because the hydroponic substrate has a low height, described herein, in the dry state, a transportation load may be maximized by weight, not volume. This means that a higher volume at a weight of the herein-disclosed substrate may be transported as opposed to a lower volume at the same weight of another substrate such as rockwool. The substrate described herein is thus a technical solution for maximizing load by weight instead of volume, and minimizing carbon footprint stemming from transportation of a substrate to a grower. Non-limiting examples illustrating the compression-expansion relationship of the hydroponic substrate are shown in FIGS. 27A and 27B.

The hydroponic substrate may be made from a single type of fiber having loose fiber density of about 0.5-8, 0.8-5, or 1-4 lbs/ft³ or 8-128, 13-80, or 16-64 kg/m³. The loose fiber density may be about 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, or 8.0 lbs/ft³. The loose fiber density may be about 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, or 128 kg/m³. The loose fiber density may be density of the fiber of the substrate before the substrate is compressed. The loose fiber density may be density of the fiber laid onto the conveyor belt or into a press container prior to compression. The loose fiber density may be density of the laid fiber which has been manually or mechanically pre-pressed prior to the heated press compression. The loose fiber density may be called initial density.

The loose fiber density above may be defined at initial moisture content of about 6-75, 12-50, 15-30, or 16-25 wt. %. The loose fiber density above may be defined at initial moisture content of about 6-20, 12-15, or 15-12 wt. %. The initial input fiber material may have a moisture content or about 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, or 75 wt. %. Preferably, the initial moisture content is about 5-20, 8-15, or 10-12 wt. % lower than the target final moisture content.

The hydroponic substrate may be made from two or more types of fiber discussed below. The fiber density of the substrate having two or more types of fiber may be referred to as blended fiber density. The blended fiber density refers to an overall density of the fiber mix having two or more types of fiber. The blended loose fiber density may be about 0.5-20, 2-15, or 5-10 lb/ft³. The blended loose fiber density may be about 8-320, 32-240, or 80-160 kg/m³. The blended loose fiber density may be about 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 lb/ft³. The blended loose fiber density may be about 8, 10, 15, 20, 25, 30, 35, 40, 45, 50, 55, 60, 65, 70, 75, 80, 85, 90, 95, 100, 105, 110, 120, 130, 140, 150, 160, 170, 180, 190, 200, 210, 220, 230, 240, 250, 260, 270, 280, 290, 300, 310, or 320 kg/m³. The blended loose fiber density may be defined at initial moisture content of about 6-75, 12-50, 15-30, or 16-25 wt. %.

The hydroponic substrate may be made from at least one type of fiber and heat-treated mineral particles, discussed below. The density of the substrate having fiber and heat-treated mineral particles may be referred to as mixed loose material density. The mixed material density may be about 1-30, 5-25, or 10-20 lb/ft³. The mixed loose material density may be about 16-480, 80-400, or 160-320 kg/m³. The mixed loose material density may be about 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 21, 22, 23, 24, 25, 26, 27, 28, 29, or 30 lb/ft³. The mixed loose material density may be about 16, 20, 25, 30, 35, 40, 45, 50, 55, 60, 65, 70, 75, 80, 85, 90, 95, 100, 105, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, or 480 kg/m³. The mixed loose material density may be defined at initial moisture content of about 6-75 wt. %.

The density of a layer, the hydroponic substrate, or both formed by compression may be about, at least about, or at most about 30 lb/ft³ or 480.6 kg/m³. The density of a layer, the hydroponic substrate, or both may be about 15-70, 20-50, 25-45, or 30-35 lb/ft³ or 240.3-1121.3, 320.4-800.1, 400.5-720.8, or 480.6-560.6 kg/m³. The density of a layer, the hydroponic substrate, or both may be about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 lb/ft³ or 240, 256, 272, 288, 304, 320, 336, 352, 368, 384, 400, 416, 432, 448, 464, 480, 496, 512, 528, 544, 560, 576, 592, 608, 624, 640, 656, 672, 688, 704, 720, 736, 752, 768, 784, 800, 816, 832, 848, 865, 881, 897, 913, 929, 945, 961, 977, 993, 1009, 1025, 1041, 1057, 1073, 1089, 1105, or 1121 kg/m³. The density values relate to the dry compressed state, hydrated state, or both. A layer may have substantially even or the same density throughout its length.

The density may be assessed using “Procedures for Determining Physical Properties of Horticultural Substrates Using the NCSU Porometer” by Horticultural Substrates Laboratory, Department of Horticultural Science, North Carolina State University in Raleigh, North Carolina, hereinafter “NCSU Porometer analysis” which is incorporated in its entirety by reference herein. The density may refer to the ratio of the mass of dry solids to the bulk volume of the substrate. The bulk volume may include the volume of solids and pore space. The mass may be determined after drying a packed core to constant weight at 221° F. (105° C.), and volume is that of the sample in cylinders.

The density of the hydroponic product may be different in different locations of the substrate. As the layers are stacked on top of one another, a gap may form between two individual layers. The gap may also contribute to non-linear or non-consistent increase of substrate height with a growing number of layers. Alternatively, the increase may be linear if the gaps are generally minimal or non-existent. The gap may measure about 0.1-1, 0.2-0.8, or 0.3-0.7 mm. The gap may measure about 0.1, 0.2, 0.3, 0.4, 0.5, 0.6, 0.7, 0.8, 0.9, or 1 mm. Non-limiting example gaps 72 can be seen in FIGS. 5, 6, and 11.

Dry bulk density, expanded dry density, or fiber density after compression and hydration may be assessed by a method discounting moisture from a hydrated sample. The values of dry density, minus the moisture, may thus be lower than the density values listed above. Example expanded dry density with discounted moisture values of the hydroponic substrate may be about 3.0-20.0, 4.8-10.0, 5.3-6.8, or 5.2-6.5 lbs/ft³. The expanded dry density may be about 3.0, 3.2, 3.5, 3.7, 4.0, 4.2, 4.5, 4.7, 4.8, 5.0, 5.2, 5.3, 5.5, 5.7, 6.0, 6.2, 6.5, 6.7, 7.0, 7.2, 7.5, 7.7, 8.0, 8.2, 8.5, 8.7, or 9.0 lbs/ft³. The expanded dry density may be about 48.1-320, 76.9-160.1, 84.9-108.9, or 83.3-104.1 kg/m³. The expanded dry density may be about 48.1, 51.3, 56, 59.2, 64, 67.3, 75.3, 76.9, 72, 77, 80, 82, 84.9, 85, 87, 90, 92, 95, 97, 100, 102, 105, 107, 110, 112, 115, 117, 120, 122, 125, 127, 130, 132, 135, 137, 140, 142, or 145 kg/m³.

The expanded dry density of the blended material, or expanded dry blended density may be about 3-40, 5-30, or 10-20 lb/ft³. The expanded dry blended density may be about 48-640, 80-480, or 160-320 kg/m³. The expanded dry blended density may be 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 21, 22, 23, 24, 25, 26, 27, 28, 29, 30, 31, 32, 33, 34, 35, 36, 37, 38, 39, or 40 lb/ft³. The blended loose fiber density may be about 48, 50, 55, 60, 65, 70, 75, 80, 85, 90, 95, 100, 105, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630 or 640 kg/m³.

The expanded dry density of the mixed material may be about 3-50, 5-40, or 10-30 lb/ft³. The expanded dry density of the mixed material may be about 48-800, 80-640, or 160-480 kg/m³. The expanded dry density of the mixed material may be about 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 lb/ft³. The expanded dry density of the mixed material may be about 48, 50, 55, 60, 65, 70, 75, 80, 85, 90, 95, 100, 105, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, or 800 kg/m³.

One of the properties the hydroponic substrate disclosed herein may be characterized by is moisture content (MC). The MC refers to the percent moisture found in a sample on a wet mass basis. MC may be calculated by: [(Wet weight−Dry weight)/Wet weight]×100. The MC denotes how much of a particular sample is comprised of water. The MC may be assessed using the NCSU Porometer analysis referenced above. Another non-limiting example way to assess MC may be via moisture scale Ohaus MB120.

The hydroponic substrate may be prepared from fiber having initial MC of about 6-75, 12-40, or 15-30 wt. %. The loose fiber MC may be about, at least about, or at most about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75 wt. %.

Preferably, the initial moisture content may be about 5-20, 8-15, or 10-12 wt. % lower than the target final moisture content of the substrate in the dry state. For example, the input fiber material may have MC of about 16 wt. % and the final substrate in the dry state may have MC of about 6 wt. %. Alternatively, the input fiber material may have MC of about 20 wt. % and the substrate in the dry state may have MC of about 10 wt. %.

Besides having MC within the ranges described herein, the input material should be naturally hydrophilic and rewettable. A hydroponic substrate should be hydrophilic. Hydrophilicity means having affinity for water, being capable of interacting with water through hydrogen bonding. A hydrophilic material may thus bind water, retain it, and provide it to plants growing in a hydrophilic substrate. The opposite of hydrophilicity is hydrophobicity which relates to a physical property of a material to repel a mass of water. A hydroponic substrate which is hydrophilic may repel water instead of making it available for plants. An example of a naturally hydrophobic substrate is rockwool which can be temporarily rendered hydrophilic, by inclusion of a surfactant. When the surfactant is depleted, the rockwool material turns hydrophobic and is not rewettable.

It was unexpectedly discovered that moisture content of the loose initial input fiber below 6 wt. % may be unsuitable because of its hydrophobicity. For example, loose wood fiber input material having MC below 6 wt. % may be hydrophobic while at MC of 6 wt. % or higher such as at 16 wt. % may be hydrophilic. The initial MC at certain density may thus determine hydrophilic or hydrophobic nature of the substrate and its ability to rewet and provide continued availability of water and nutrients to a plant grown in the substrate.

Additionally, it was surprisingly discovered that the compression process affects hydrophilicity, retaining hydrophilicity of a material while lowering its MC. It was observed that at about 4-6 wt. % MC, loose initial wood fiber material was hydrophobic. But a substrate made from loose initial wood fiber material having MC higher than 4-6 wt. %, such as 16 wt. %, resulted in a hydrophilic substrate even when the final MC of the substrate was 4-6 wt. %. The compression process described below thus results in a hydrophilic substrate at MC at which the fiber in a loose form may be hydrophobic. The compressed state of the material thus renders the material suitable for use as a hydroponic substrate.

To demonstrate the hydrophilic nature of the substrate, a float test was conducted. The float test assessed ability of the material to interact with water. The test results are shown in FIG. 32. Examples D1-D represent the compressed wood fiber substrate made from wood fiber having initial MC of 16-18 wt. %, the final substrate having MC of 6 wt. % in dry state. Examples D1-D3 sank within a minute, indicating their hydrophilic nature of interacting with water on a molecular level. In contrast, comparative examples e1-e3 represent loose wood fiber having MC of 6 wt. %. Comparative examples e1-e3 remained floating on the surface of the water, indicating their hydrophobic nature and repelling water. An additional test confirming the concept of the effect of compression on hydrophilic/hydrophobic nature of a substrate was conducted with Examples 102-105 and comparative examples f1-f4 listed below in the Examples section.

The MC of the hydroponic substrate after compression but before hydration is the MC in the dry state. MC in the dry state may be up to about or at most about 20 wt. %. The MC in the dry state of the hydroponic substrate after the compression process, during storage, transport, or both may be up to about or at most about 20 wt. %. The MC may be about 5-10 wt. %. The MC may be about 4-6 wt. %. The MC may be about, at least about, or at most about 4, 5, 6, 7, 8, 9, or 10 wt. %. The MC may be about 1-20, 4-15, or 6-10 wt. %. The MC may be about or less than about 20, 19, 18, 17, 16, 15, 14, 13, 12, 11, 10, 9, 8, 7, 6, 5, 4, 3, 2, 1, or 0.5 wt. %. While in the dry state, MC higher than 20 wt. % may cause one or more undesirable effects such as premature swelling of the substrate, breakage during handling, increased weight influencing storage and transportation costs, undesirable microbial activity, the like, or a combination thereof. If a binder such as a cellulosic binder, synthetic biner, is used, the MC after compression, before hydration, may be up to about 30 wt. %.

The MC of the hydroponic substate after hydration may be at least about 20 wt. %. The MC of the hydroponic substate after hydration may be significantly higher than 20 wt. %, for example up to about 98 wt. %. A fully saturated substrate may have MC in the hydrated state at about 100 wt. %. The MC of the hydrated expanded state slab may be about 50-98, 60-95, or 65-90 wt. %. The MC of the hydrated expanded state slab may be about 50, 55, 60, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, or 98 wt. %. Example MC of non-limiting examples of the hydroponic slab disclosed herein is shown in Table 4 below.

TABLE 4
Moisture content of a non-liming example
hydroponic slab with 1-6 layers.

| No. of layers of a | MC dry state | MC hydrated state |
|---|---|---|
| hydroponic substrate | [wt. %] | [wt. %] |
| 1 | 6 | 93 |
| 2 | 6 | 91 |
| 3 | 6 | 89 |
| 4 | 6 | 88 |
| 5 | 6 | 86 |
| 6 | 6 | 85 |

The total porosity of the hydroponic substrate may be about 85-99, 88-98, or 90-97%. The total porosity of the hydroponic substrate may be about or at least about 85, 86, 87, 88, 89, 90 91, 92, 93, 94, 95, 96, 97, 98, or 99%. The total porosity may be assessed using a Porometer testing described below.

The container capacity of the hydroponic substrate may be about 20-95, 22-80, or 25-65%. The container capacity of the hydroponic substrate may be about 20, 22, 24, 25, 26, 28, 30, 32, 34, 35, 36, 38, 40, 42, 44, 45, 46, 48, 50, 52, 54, 55, 56, 58, 60, 62, 64, 65, 66, 68, 70, 72, 74, 75, 76, 77, 78, 80, 81, 85, 87, 90, 92, or 95%. The container capacity may be assessed using a Porometer testing described above.

The volume of air space of the herein-disclosed hydroponic substrate may be about 10-76, 15-68, or 20-65%. The volume of air space of the hydroponic substrate may be about 10, 11, 12, 13, 14, 15, 16, 17, 18, 19, 20, 21, 22, 23, 24, 25, 26, 27, 28, 29, 30, 32, 34, 35, 36, 38, 40, 42, 44, 45, 46, 48, 50, 52, 54, 55, 56, 58, 60, 62, 64, 65, 66, 68, 70, 72, 74, 75, or 76 vol. %. The percent volume of air space may refer to air holding capacity measured as the percent volume of a substrate that is filled with air after the material is saturated and allowed to drain. It is the minimum amount of air the material will have. The analysis may be made using the NCSU Porometer analysis, referenced above.

The hydroponic substrate may have advantageous pH buffering capacity. While optimal pH differs for different types of plants, when pH drifts beyond a desirable range, nutrient availability is negatively affected. Additionally, a drop or increase in pH for some species includes exposure to sensitivities and toxicity towards certain elements such as iron. The hydroponic substrate disclosed herein is structured to enable easy change or tuning of pH to release or lock up nutrients. A grower may thus find a valuable advantage in easy pH adjustment to provide the optimal pH for the plants grown in the disclosed substrate.

The hydroponic substate in the hydrated state may have a volumetric water content (VWC), measured by the Porometer testing described above, UF method, or sandbox method, or other methods such as measuring weight and/or volume change after addition of water. VWC may be about 0.3-1.5, 0.6-1.4, or 0.7-1.3 g/cm³. The VWC may be about 0.3, 0.4, 0.5, 0.6, 0.7, 0.8, 0.9, 1.0, 1.1, 1.2, 1.3, 1.4, or 1.5 g/cm³. The VWC may be presented as a percentage, % vol/vol.

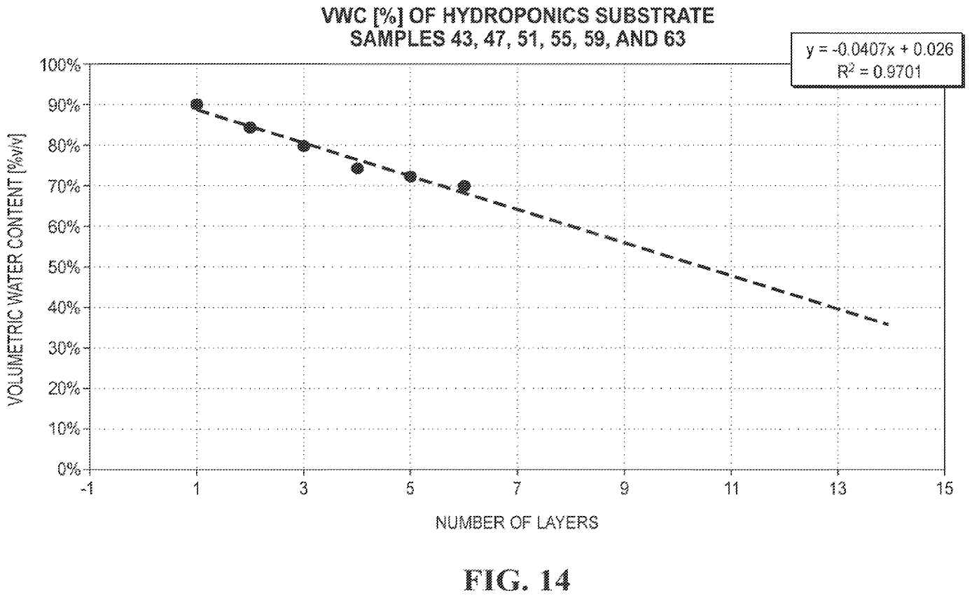

The VWC may be dependent on several factors including the number of layers. With the increasing number of layers, volumetric water content may be decreasing. The decrease may be linear. Non-limiting example VWC for hydroponics substrates in relation to number of layers is shown in the Table 5 below and in FIG. 14.

TABLE 5
VWC in relation to a number of layers of the hydroponic substrate

| | Number of layers in the substrate | | | | | |
|---|---|---|---|---|---|---|
| | 1 | 2 | 3 | 4 | 5 | 6 |
| Moisture content | 94% | 83% | 81% | 75% | 74% | 68% |
| of the substrate | 89% | 82% | 81% | 76% | 73% | 67% |
| [%] | 90% | 84% | 80% | 74% | 72% | 70% |
| | 93% | 86% | 82% | 79% | 77% | 71% |
| Average | 92% | 84% | 81% | 76% | 74% | 69% |

The hydroponic substate may have variable composition. The compressed material may include fiber material. The fiber or fibrous material may include interlocked, intertwined fibers which may contribute to the self-supporting quality of the substrate. The substrate may include a single type of fiber, at least one type of fiber, at least two types of fiber, or more than two types of fiber. The fiber may be a fiber blend. The fiber may include wood, bark, coir, sisal, jute, straw, rice hulls, hemp, alfalfa, flax, peat, hammermilled fiber such as hammermilled tree substrate, hammermilled pine tree substrate, sawdust, compost, manure, paper, the like, or a combination thereof. The hydroponic substrate may include substantially inert materials like the wood fiber, non-inert materials, or both. The substrate may be free of an added binder, surfactant, or both.

The wood fiber may be soft wood, hard wood, or a combination thereof. The wood may be fibrous wood processed with heat, pressure, and/or steam. The wood fiber may be fiber of yellow poplar, cedar such as Western red cedar, fir such as Douglas fir, California redwood, pine such as Ponderosa, Sugar, White, Red, Jack, Longleaf, Turkish, Virginia, Lodgepole, Pitch, Maritime, Sand, Slash, Loblolly, Bristlecone, Austrian, Japanese Black, Japanese White, Lacebark, Mediterranean, Monterey, Caribbean, Queensland, Bunya, Norfolk Island, and Yellow varieties of pine fiber.

The bark may be soft wood bark, hard wood bark, or a combination thereof. The bark may be composted bark, bark processed in a retruder. The bark may be pine tree bark. The bark may be fibrous bark processed with heat, pressure, and/or steam. The bark fiber may be from yellow poplar, cedar such as Western red cedar, fir such as Douglas fir, California redwood, pine such as Ponderosa, Sugar, White, Red, Jack, Longleaf, Turkish, Virginia, Lodgepole, Pitch, Maritime, Sand, Slash, Loblolly, Bristlecone, Austrian, Japanese Black, Japanese White, Lacebark, Mediterranean, Monterey, Caribbean, Queensland, Bunya, Norfolk Island, and Yellow varieties of pine fiber.

The hydroponic substrate may include 100 wt. or vol. % of a single type of fiber. Alternatively, the substrate may include about 1-99, 10-80, or 30-50 wt. or vol. % of a first type of fiber and about 1-99, 10-80, or 30-50 wt. or vol. % of a second type of fiber. Potentially, the substrate may also include about 1-99, 10-80, or 30-50 wt. or vol. % of a third type of fiber. More types of fiber are contemplated. The substrate may include even or uneven wt. or vol. % of each type of fiber. The wt. % is based on the total weight of the substrate.

In a non-limiting example, the substrate may include at least about 50 wt. % wood fiber, the remainder being at least one other type of fiber or another material named herein. In another example, the substrate may include about, at least about, or at most about 10, 20, 30, 40, 50, 60, 70, 80, or 90 wt. % wood fiber and the remainder at least one other type of fiber or material named herein. For example, the substrate may include about 80 wt. % wood fiber and 20 wt. % coir/peat/bark, and/or another fiber/material. The substrate may include about 70 wt. % wood fiber and about 30 wt. % another fiber/material. The wt. % is based on the total weight of the substrate.

In a non-limiting example, the hydroponic substrate may include 100 wt. or vol. % wood fiber. The substrate may thus exclude one or all of bark, composted bark, bark processed in a retruder, coir, sisal, jute, straw, rice hulls, hemp, alfalfa, flax, hammermilled fiber such as hammermilled tree substrate, hammermilled pine tree substrate, paper, sawdust, compost, manure, or the like. In another embodiment, the substrate may include about 5 or more wt. or vol. % bark.

Non-limiting example material may include wood fiber characterized by about 0.2-6.0, 0.6-3.8, or 1-3.5 g/10 g material 8 mesh sieve. Non-limiting example material may include wood fiber characterized by about 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.1, 3.2, 3.3, 3.4, 3.5, 3.6, 3.7, 3.8 3.9, or 4.0 g/10 g material 8 mesh sieve. In other words, a non-limiting example material may include about 2-60, 6-38, or 10-35% of the wood fiber on 8 mesh sieve. Non-limiting example material may include about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60% of the wood fiber on 8 mesh sieve. The wood fiber may be made from wood chips using heat, steam, and/or pressure. The wood fiber may be sterile.

The hydroponic substrate may include fiber and heat-treated mineral particles. The fiber and heat-treated mineral particles may be blended or mixed together, forming a mixed or mixed-media substrate. The heat-treated mineral particles may include calcined particles. The calcined particles may be based on clay. The calcined clay particles may include one or more types of clay. The clay may include, for example, smectite clay(s) including the following minerals: montmorrilonite, beidellite, nantronite, saponice, hectorite. The clay may be gray, red, or both. The clay particles may be processed in the following manner for the purposes of the disclosed application. The clay may be calcined at a temperature of about 1000 to 1400, 1100 to 1350, or 1200 to 1300° F. or 537-760, 593-732, or 648-704° C. The clay may be subsequently sized or micronized, for example, by grinding. The clay may be provided in various sizes. The heat-treated mineral particles may be added to the hydroponic substrate pre- or post-compression.

The mixed-media substrate may include about 1-99, 10-80, or 30-50 wt. or vol. % of fiber, single fiber or fiber blend, and about 1-99, 10-80, or 30-50 wt. or vol. % of heat-treated mineral particles.

The hydroponic substrate may include up to about 0.1, 2, 5, 10, 15, 20, or 25 wt. or vol. % of additional components/materials. The substrate may include about 0.1, 0.2, 0.3, 0.5, 0.8, 1, 2, 3, 4, 5, 6, 7, 8, 9, 10, 11, 12, 13, 14, 15, 16, 17, 18, 19, 20, 21, 22, 23, 24, or 25 wt. or vol. % of additional components/materials. The additional components/materials may include one or more of pigments, pigment precursors, fertilizer(s), macronutrient(s), micronutrient(s), mineral(s), mineral particle(s), binder(s), natural gum(s), biostimulant(s), interlocking manmade fiber(s), interlocking biodegradable fiber(s), and the like, and combinations thereof. The hydroponic substrate may be free of one or more of pigments, pigment precursors, fertilizer(s), macronutrient(s), micronutrient(s), mineral(s), binder(s), natural gum(s), biostimulant(s), interlocking manmade fiber(s), interlocking biodegradable fiber(s), and the like, or combinations thereof. The additional component(s) may be added to the hydroponic substrate pre- or post-compression.

For example, one or more of the additional components may be provided onto the layered initial material before compression. The application may be by dusting, spraying, sprinkling, or otherwise. Alternatively, the application of the additional components may be done after compression, for example by putting them on the top layer of the substrate, piercing the substrate in predetermined locations to insert the additional components. The piercing may be via the top layer, sides, and/or the bottom layer.

Fertilizers such as nitrogen fertilizers, phosphate fertilizers, potassium fertilizers, compound fertilizers, and the like may be used in a form of granules, powder, prills, or the like. For example, melamine/formaldehyde, urea/formaldehyde, urea/melamine/formaldehyde and like components may serve as a slow-release or control-release fertilizer. Fertilizers having lesser nutritional value, but providing other advantages such as improving aeration, water absorption, or being environmental-friendly may be also used. The source of such fertilizers may be, for example, animal waste, compost, and/or plant waste.

Control-release fertilizers with polyolefin, polyurethane, polymeric, and/or biodegradable coating may be incorporated into the hydroponic substrate after compression. The control-release fertilizers may be tailored for a specific growing goal such as yield, length of a growing season, and/or plant species.

Nutrients are well-known and may include, for example, macronutrient, micronutrients, and minerals. Examples of macronutrients include calcium, chloride, magnesium, phosphorus, potassium, and sodium. Examples of micronutrients are also well-known and include, for example, boron, cobalt, chromium, copper, fluoride, iodine, iron, magnesium, manganese, molybdenum, selenium, zinc, vitamins, organic acids, and phytochemicals. Other macro- and micronutrients are well known in the art.

The mineral particle(s) may include perlite, vermiculite, sand particles, zeolite, hydrated aluminosilicate minerals that contain alkali and alkaline-earth metals, or a combination thereof. The mineral particle(s) may be treated or untreated.

The binders may be natural or synthetic. For example, the synthetic binders may include a variety of polymers such as addition polymers produced by emulsion polymerization and used in the form of aqueous dispersions or as spray dried powders. Examples include styrene-butadiene polymers, styrene-acrylate polymers, polyvinylacetate polymers, polyvinylacetate-ethylene (EVA) polymers, polyvinylalcohol polymers, polyacrylate polymers, polyacrylic acid polymers, polyacrylamide polymers and their anionic- and cationic-modified copolymer analogs, i.e., polyacrylamide-acrylic acid copolymers, and the like.

Thermoset binders may also be used, including a wide variety of resole and novolac-type resins which are phenol/formaldehyde condensates, melamine/formaldehyde condensates, urea/formaldehyde condensates, and the like. Most of these are supplied in the form of aqueous solutions, emulsions, or dispersions, and are generally commercially available.

The natural binder may include a variety of starches such as corn starch, modified celluloses such as hydroxyalkyl celluloses and carboxyalkyl cellulose, or naturally occurring gums such as guar gum, gum tragacanth, and the like. Natural and synthetic waxes may also be used.

The substrate may; however, be free of an added binder.

Biostimulants may include any substance or microorganism that, when applied to seeds or plants, stimulates natural processes to enhance or benefit nutrient uptake, nutrient use efficiency, and/or crop quality and yield. Biostimulants may include many different types. Non-limiting example biostimulants include enzymes, proteins, peptides, amino acids, protein hydrolases and/or other N-containing compounds, micronutrients such as Al, Co, Na, Se and Si, phenols, salicylic acid, monosilicic acid, humic acid, fulvic acid, seaweed extract, botanicals, biopolymers such as chitosan, inorganic compounds such as amorphous silica (SiO₂·nH₂O), silicates such as potassium silicate, calcium silicate, microbial biostimulants including mycorrhizal and non-mycorrhizal fungi, fungal spores, bacterial endosymbionts (like Rhizobium) and Plant Growth-Promoting Rhizobacteria, biologicals, etc. The biostimulants may be included as part of various components such as rice hulls, fish meal, byproducts of dairy production, etc.

The hydroponic substrate may have various dimensions, shape, configuration, or a combination thereof. The substrate may have a shape of a cube, cuboid, cylinder, rectangular prism, or rectangular parallelepiped. Other shapes are contemplated. A preferred shape may be a rectangular prism or a cuboid. The substrate may form a slab, mat, grow cube, or another type of a hydroponic substrate article.

For example, the substrate may be formed as a slab having a length greater than the other dimensions. Non-limiting example slab sizes may include the height discussed above. The hydroponic slab may have width which may be about, at least about, or at most about 3 to 30, 4 to 20, 6 to 16, or 8 to 12 inches or 4.6 to 76.2, 10.2 to 50.8, 15.2 to 40.6, or 20.3 to 30.5 cm. The length may be about, at least about, or at most about 5 inches to 10 feet, 10 inches to 8 feet, or 50 inches to 5 feet or 12.7 cm to 3 m, 25.4 cm to 2.4 m, or 1.27 m to 1.52 m. A non-limiting example compressed slab may have the following dimensions, in the hydrated expanded state: 39.5″×8″×3″ (100 cm×20 cm×7.5 cm), 39.5″×6″×4″ (100 cm×15 cm×10 cm), 100×20×7.5 cm, 50×24×2.5 cm, 49.5×24×1 cm, 10×20×1 cm, or the like. Other dimensions of the substrate are contemplated. The slab may be also dimensioned as a relatively thin roll.

The hydroponic substrate may be formed into different forms than a slab. For example, the substrate may be configured as a cube, grow cube, starter cube, or propagation cube. The cube may have substantially the same size on at least two sides, in the dry unexpanded state, and two or three sides in the hydrated expanded state. Non-limiting example dimensions of the substrate cube may be, in the dry unexpanded state, 2.3×2.3×0.5 cm, 4.6×4.6×1.05 cm, 9.5×9.5×3.25 cm, 14.5×14.5×4.35 cm, 19.5×19.5×7.1 cm. The 2.3×2.3×0.5 cm substrate may expand to a 2.5 cm cube in the expanded hydrated state. The 4.6×4.6×1.05 cm substrate may expand to a 5.0 cm cube in the expanded hydrated state. The 9.5×9.5×3.25 cm substrate may expand to a 10.0 cm cube in the expanded hydrated state. The 14.5×14.5×4.35 cm substrate may expand to a 15.0 cm cube in the expanded hydrated state. The 19.5×19.5×7.1 cm substrate may expand to a 20.0 cm cube in the expanded hydrated state.

Non-limiting example dimensions of the substrate cube may be, in the hydrated expanded state, 1×1×1 inch (2.5×2.5×2.5 cm), 2×2×2 inches (5×5×5 cm), 4×4×4 inches (10×10×10 cm), 6×6×6 inches (15.2×15.2×15.2 cm), or 8×8×8 inches (20×20×20 cm). Other dimensions are contemplated. For example, the cube may not be a precise cube such that at least one side may have a different dimension than the remaining sides. The “cube” may thus be a cuboid. In a non-limiting example, the dimensions of the substrate may be, in the hydrated expanded state, about 15×15×14 cm, 10×10×8 cm, 10×10×6.4 cm, 10×10×9 cm, or the like.

The hydroponic substrate may be provided in a wrap, bag, foil, cover, or the like, generally called wrapping. The wrapping may be synthetic or natural, biodegradable. The wrapping may be breathable, permeable, or impermeable, depending on a need of a specific application. The material for the wrapping may include plastic, thermoplastic, textile, woven, non-woven material, the like, or a combination thereof. The material may be opaque, dark, non-translucent, non-transparent, see-through, translucent, or transparent.

The wrapping may be installed around the substrate by sealing, thermo-sealing, hot-sealing, stitching, with an adhesive, with staples, the like, or a combination thereof. The wrapping may have a tight fit around the substrate. Alternatively, the wrapping may be loose to a predetermined degree around a dry state substrate such that when the substrate is hydrated, there is room within the wrapping for the substrate's hydrated expansion.

Alternatively, the substrate may be wrap-free. As was mentioned above, the substrate can retain its self-supporting structure and vertical and horizontal stability even after hydration. Hence, the substrate does not require a support article such as a wrap to retain moisture or structure. Thus, the herein-disclosed substrate provides several other advantages. Firstly, by being structurally sound and having moisture distribution essentially throughout the entire volume, the substrate may be used without any wrap, thus being entirely bio-based and bio-degradable, environmentally friendly, and sustainable. Additionally, the absence of a cover may be used for air pruning. Air pruning happens when roots are exposed to air in the absence of high humidity, their tips dry and fall off. In reaction to the tips dying off, the plant begins to grow more roots out of the main tap root and mine for nutrition while spreading the rootzone. An absence of a bag covering allows for air pruning of potential plants grown in the substrate. Additionally, the new roots may be more fibrous roots rather than thicker, denser water roots. The finer roots are generally more desirable because they have greater surface area and are capable of a greater nutrient uptake than the thicker roots. A greater capability of nutrient uptake may be beneficial for yields and fruit growth.

The air pruning may be encouraged by utilizing the herein-disclosed substrate alone or with a row cover, typically used in agricultural field settings. A row cover may be beneficial to prevent algae, keeping the root system cooler, and providing increased air circulation in comparison to a bag enclosing the substrate on all sides. A row cover may be applied over the top of the substrate and loosely over one or more sides.

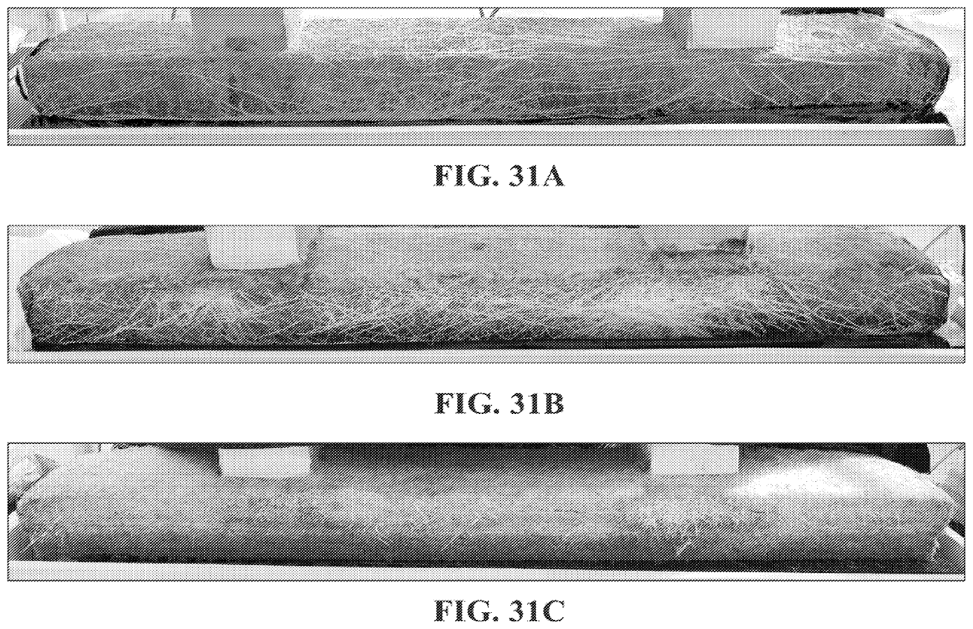

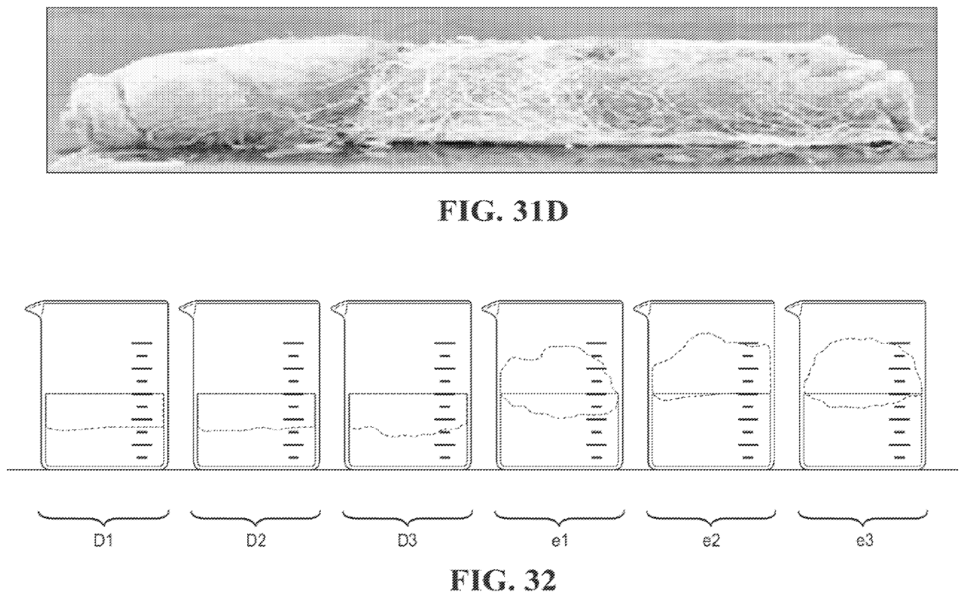

A comparison set of examples relating to root pruning is shown in FIGS. 31A-C after the wrapping removal. FIG. 31A shows a root structure of a plant grown in a prior art rockwool substrate covered in a bag for 20 days. The same species of a plant was also grown in a compressed wood fiber substrate disclosed herein with a bag for 20 days, shown in FIG. 31B. Another plant of the same species was grown in the same compressed wood fiber substrate with a row cover for 20 days, the substrate shown in FIG. 31C. The cover was removed after 20 days of growth from all the substrates. As can be seen, FIG. 31C features root structure which is different from FIGS. 31A and 31B, featuring more fine roots concentrated within the substrate, i.e. featuring a higher root surface area.

For further comparison, a slab made from loose wood fiber packed into a wrapping is shown in FIG. 31D after the wrapping removal. As can be seen in FIG. 31D, the substrate has uneven surface, dry areas except for the central portion of the substrate, and the roots of the plant concentrated in a limited central portion of the substrate only. The uneven surface is not suitable for installation of grow cubes because the grow cubes would lean and jeopardize stability of the plant grown within. The entire volume of the slab was not utilized, and moisture was not evenly distributed, thus limiting where roots can grow.

In one or more embodiments, the substrate may be semi-enclosed in a wrap which leaves one or more sides open while covering the remaining sides. For example, the wrap may be applied over the top side, bottom side, and two additional sides only, leaving opposing two sides free of a wrap.

Alternatively, the substrate may be used in an open-face container. The substrate may be inserted within a container having a bottom and sides and being free of a top. The inserted substrate may fit snuggly within the container such that the sides of the substrate are in direct contact with the sides of the container. Alternatively, the container may have greater dimensions than the substrate such that the substrate's bottom portion is the only portion in direct contact with the container. A non-limiting example of the container embodiment may be a substrate layer disclosed herein used for microgreens production. The layer may be provided nutrients by irrigation such as drip irrigation or partially or fully inundating the layer with a nutrient liquid bath.

The layers of the substrate are configured to stay together, one on top of the other, stacked. The layers may cooperate or be in communication with one another. The layers may be and remain stationary with respect one to another once stacked, for example due to friction forces between individual discreet layers and their fiber.

To achieve the stacked configuration, the layers may be bound or otherwise secured together, stitched together, one or more holes/openings/apertures may be made through the substrate and utilized for securing, or a combination thereof. Additionally or in the alternative, the wrapping may assist with keeping the layered substrate in its stacked position. The wrapping may be the only measure taken to keep the substrate in the stacked position. Non-limiting examples of the wrapping 60 are shown in FIGS. 1B, 1C, 3B, 9, 10, 12, 24A, 25, 26B, 26C, 35, and 36.

The substrate may be free of an added adhesive or binder binding the two or more compressed layers to one another. Moreover, the substrate may be free of an added adhesive or binder throughout the substrate. Alternatively, the substrate layers may be attached to one another with a non-toxic binder such as non-toxic glue. In a non-limiting example, the grow cube layers may be attached to one another with a non-toxic glue before being inserted into a wrapping to ensure the layers remain in a stacked formation. The attachment with glue is done after the pressing process is finished so that the process is free of any added adhesive, glue, or binder. The glue may be based on polyvinyl alcohol (PVA) or another biodegradable, dissolvable chemistry.

Alternatively still, the layers may be secured together with a film or tie. The tie may be configured to encircle or enclose all the layers together and keep them in a stacked position in the dry state within a wrapping or without a wrapping. The film or tie may be tied, heat-sealed, heat-shrunk, or otherwise secured so its ends connect, do not release prematurely, and secure the layers together. The tie may be elastic, compostable, certified organic, food safe, or a combination thereof.

In the hydrated state, the tie may be configured to release. This may be done, for example, by providing a dissolvable tie which is water soluble. The tie may be configured to dissolve upon contact with water, thus releasing the hold of the layers which are then free to swell and expand as intended. At the same time, for transportation and storage, the layers are secured in a stacked formation, preventing movement, sliding of the discreet layers in the dry state. The dissolvable tie may include a polymeric material such as biodegradable, water soluble material including a starch, PVA, cellulose, the like, or a combination thereof. The tie material may be food safe, biobased, biodegradable. A non-limiting example of a dissolvable film/tie is shown in FIG. 36. FIG. 36 depicts a non-limiting example of a hydroponic substrate having a plurality of layers 51 stacked and secured together with a dissolvable tie 52. The substrate is shown in a dry state and partially inserted within a wrapping 60. Once in hydrated state, the water utilized to hydrate the substrate will dissolve the tie upon contact, the tie will release and allow for expansion of the discreet layers.

The wrapping may enclose the entire substrate. Alternatively, the wrapping may be included on one or more sides, but not all of the sides. In a non-limiting example, the wrapping may be included on the sides and/or the bottom with an open top free of the wrapping. In another non-limiting example, the wrapping may enclose all of the substrate's sides, but one or more openings 62 may be made for insertion of the plant, as is shown in the non-limiting examples of FIGS. 1C, 9, 10, 24A, and 25. The openings may be made initially at the point of production or by a consumer or grower after the point of sale. The opening may have example non-limiting dimensions of about 1-25, 3-23, or 5-20 cm². The opening may have example non-limiting dimensions of about 1, 2, 3, 4, 5, 6, 7, 8, 9, 10, 11, 12, 13, 14, 15, 16, 17, 18, 19, 20, 21, 22, 23, 24, or 25 cm².

The disclosed hydroponic slab may have even, regular, and/or uniform surface throughout its length and/or volume. The even surface may assist with efficient growing. For example, as can be seen in FIGS. 7 and 8, the substrate may be formed into slabs 64 which may be used as supports and main growing medium for a plant started in a grow cube 68. An uneven surface could jeopardize the stability of the grow cube, and in turn, stability of the growing plant.

In one or more embodiments, a process of making the compressed hydroponic substrate described herein is disclosed. The process may include one or more steps of a first process.

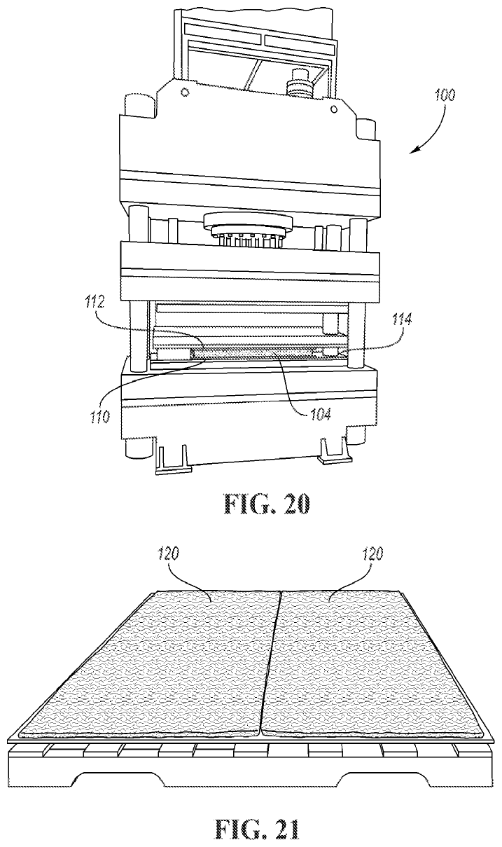

The first process may be a batch process. The first process may be conducted using a stationary press, which may be programmed to generate a predetermined amount of steam, heat, and/or pressure to form the substrate initial material(s) into the compressed hydroponic substrate disclosed herein. The press may be an industrial press, automatic, semi-automatic. A non-limiting example of the press 100 is shown in FIG. 20.

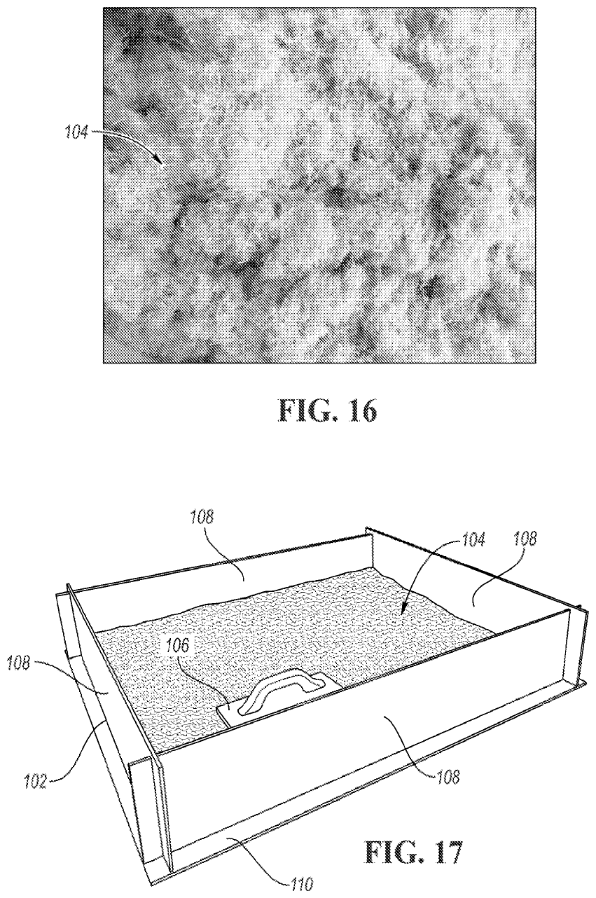

The process may include a precompression stage. During the precompression stage, the substrate materials such as fiber may be prepared for compression. The process may include filling a container 102 with the materials to a predetermined height, in a predetermined manner, or both. The materials may include fiber and optionally other materials described above. Non-limiting example of the loose fiber 104 to be used in the compression process is shown in FIG. 16. The container may be configured as a mold, cast, die, border, vessel, capsule, box, or the like. For example, the materials may be loosely laid within the boundaries of the container. The filling may be provided in several stages. The process may include pressing the material towards the bottom of the container evenly or unevenly before additional fiber is added. The process may include repeating the addition of material and pressing the material until the material reaches a predetermined height within the container.

The container may be a topless container having sides and a bottom. The container may have four side and a removable top and bottom. The top and/or bottom may be removable from the rest of the structure. The container may form a border or boundary with no top and bottom. The border or boundary may be set on a plate or sheet. The sheet may be loose, independent from the border or container. The sheet may be attachable and detachable from the container. The sheet may be temporarily attachable to the container. The container may be structured as a stencil, outlining where the initial materials are supposed to be provided. After the initial material placed onto the sheet reaches the desired predetermined height, the container may be removed. The materials may have the dimensions and/or general shape of the container. The top and bottom may be independent from the container.

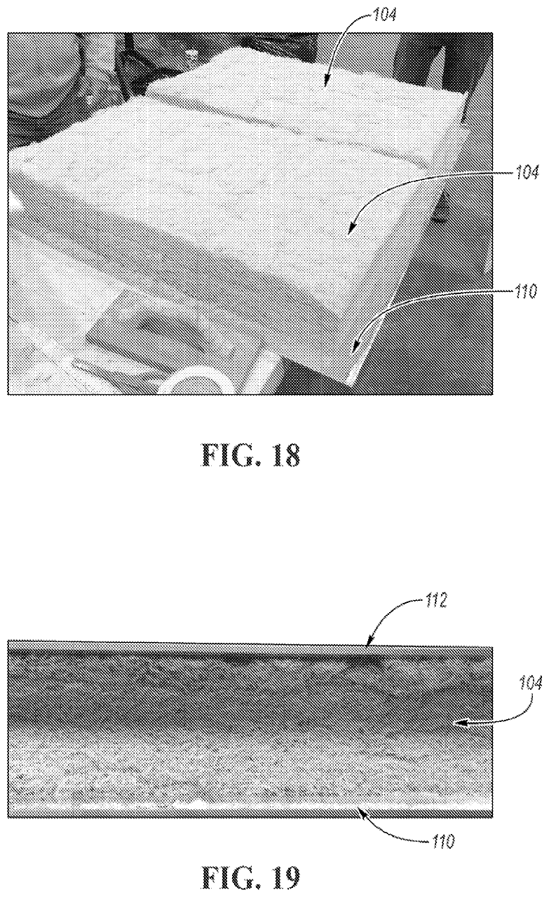

A non-limiting example of the container 102 and a pre-compression manual utensil 106 is shown in FIG. 17. The container 102 has four sides 108 which cooperate to form a predefined border. After a predetermined amount of material is laid within the boundary of the container 102 and pre-compressed into a predetermined height, the container 102 may be disassembled and the sides 108 may be removed. The fiber remains to be positioned on the bottom side of the container or a sheet 110 which may be inserted into a press. The fiber holds the general shape of the container after the removal of the side portions of the container, as can be observed in FIG. 18. The retention of the shape may be due to the structure of the fiber as described herein.

The container, or one or more portions thereof, may be disposable. For example, the bottom and top may be reusable and sides may be disposable. After the container is filled to a predetermined level, the material may remain enclosed in the container which may be moved into the press together with the material. It is anticipated that the sides may be destroyed during the pressing stage, described below.

The process may include the preparing stage. During the preparing stage, a top of the container or sheet 112 may be laid on top of the pre-compressed fiber/material. A non-limiting example of the top sheet is shown in FIG. 19. The material is thus sandwiched between two sheets 110, 112 or the top 112 and the bottom 110 of the container 102. However, the sides of the container may be removed, as is shown in the figures.

During the preparing stage, the sheets 110, 112 with the materials and/or the container may be moved into the open daylight space 114 of the press 100, as is shown in FIG. 20. The press 100 may be programmed to generate a predetermined thickness of the hydroponic, pressed layer.

The preparing stage may include providing a predetermined amount of moisture to the prepared material to generate steam during the pressing process. The moisture may be added to the top layer, bottom layer, or both. The moisture may be added only to the top layer or surface layer. The moisture may be added throughout the entire thickness of the material. The moisture may be added once or more times prior to the pressing stage. The moisture may be added in the form of water. The amount of moisture to be added may be about 30-200, 40-100, or 50-80 ml water/1 ft² of material. The amount of moisture to be added may be about 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, or 200 ml water/1 ft² of material.

In is also contemplated that no additional moisture or moist material may be added during the preparing stage. Instead, initial material with a desirable MC, as discussed above, may be used. The initial material should have consistent MC throughout its volume. MC has been found to influence thickness swell, rebound, and consistency of the substrate. Thus, the initial MC and its consistency throughout the input material plays an important role.

The preparing stage may also include preheating of the plates the initial material is loaded onto. The preheated plates may help with uniformity of the substate formation in the pressing stage.

If the initial material has a higher MC than desirable, MC may be lowered, for example by radio frequency (RF), dryer pre-press, or the like. The MC of the initial material may be lowered during the pressing stage by application of heat. The RF or microwave radiation may be also used to preheat the input fiber to enable better heat transfer into the central portions of the layers of the input material in the pressing stage.

The process may include a pressing stage. During the pressing stage, the press 100 is activated, generating heat, steam, and/or pressure for a predetermined amount of time. The pressing may be done in at least one cycle, one or more cycles, at least two cycles, or two or more cycles. The pressing stage may include a single cycle.

The conditions in each cycle may be the same or different. For example, at least one of the parameters may differ between the cycles. Within the same cycle, the amount of pressure may differ in time. For example, a single pressing cycle may include an interval of first pressure, interval of second pressure, interval of third pressure, interval of fourth pressure, interval of fifth pressure, etc. The values of the first-fifth intervals may differ from one another. In a non-limiting example, the highest value of pressure may be applied during the first interval followed by a lower pressure in a second interval, followed by a brief interval of no pressure, etc. The pressure may be released suddenly or gradually between intervals. The intervals may last the same or different amount of time. For example, the cycle may include alternating intervals of high and low pressure values which may assist with heat transfer into the central portions of the layer of the initial material which is being pressed while preventing an unwanted amount of heat transferring outside of the material.

As was mentioned above, the initial material may be preheated to warm up the initial material prior to the pressing stage. The prewarming of the initial material may enable easier management of the pressing stage and decrease cycle time.

Non-limiting values of the press parameters for the pressing stage may include the following. The pressing stage temperature or heat may be about 20-350, 30-300, or 50-250° C. The pressing stage temperature may be about 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, or 350° C. A non-limiting example press temperature target may be about 140-180° C. The press surface temperature may be about 120-150° C. If the press temperature is too low, steam may build up and not evacuate moisture, thus negatively affecting the final MC. The heat should be distributed evenly throughout the entire length/volume of the material because heat distribution may influence expansion once the substrate is hydrated. An even distribution of heat may thus contribute to even expansion of the substrate once hydrated.

Non-limiting example pressure applied during the pressing stage may be about 1-2000, 10-1500, or 100-1000 PSI. The amount of pressure may be about 1, 10, 50, 100, 150, 200, 250, 300, 350, 400, 450, 500, 550, 600, 650, 700, 750, 800, 850, 900, 950, 1000, 1050, 1100, 1200, 1250, 1300, 1350, 1400, 1450, 1500, 1550, 1600, 1650, 1700, 1750, 1800, 1850, 1900, 1950, or 2000 PSI. The amount of pressure may be the same or different in each cycle. The applied pressure may be higher in the second cycle by about 2, 5, 10, 15, or 20 times.

The dwell time may be about 1-300, 10-200, or 30-100 sec. The dwell time may be about 1, 5, 10, 15, 20, 25, 30, 35, 40, 45, 50, 55, 60, 65, 70, 75, 80, 85, 90, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or 300 sec.

The line speed may be variable and dependent on the type of press used. The line speed values shown in this application are non-limiting examples only.

After the pressing is complete, the resulting compressed hydroponic substrate layer 120 is taken out of the press with the sheets 110, 112. The process may include cooling of the layer in the press, outside of the press, or both.

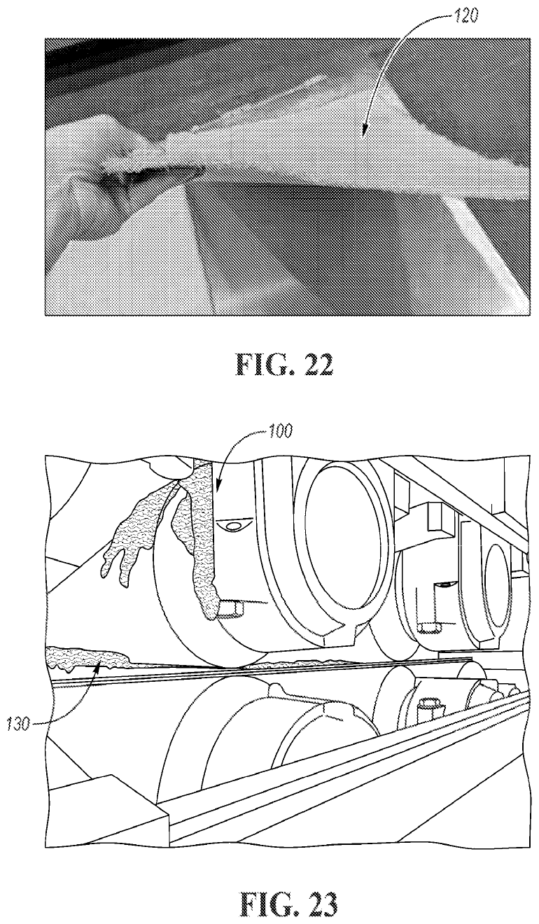

Non-limiting examples of the compressed layers are shown in FIGS. 21 and 22. As can be seen in FIG. 22, the layer is structured to have sufficient strength to withstand handling and layering to form a multi-layer hydroponic substrate described herein. Other non-limiting examples of the compressed layers are shown in FIGS. 1A, 2, 3A, 3B, 4, 5, and others.

In the compression processes described herein, the initial moisture content may vary, as was described above. Depending on the amount of the initial moisture content, different amount of heat may be used, preprogrammed, generated, or a combination thereof, during the pressing stage. For example, the higher the initial moisture content, the greater amount of heat may be added.

An alternative form of the first process may include filling a container with a material and pressing the material in the container with a press. During the alternative process, the material remains enclosed in the container for the duration of the pressing stage. After the compression is complete, the compressed substrate may be taken out of the press.

A second process disclosed herein may be a continuous process. A non-limiting example of the continuous press 100′ including a conveyor belt 130 is shown in FIG. 23. The process may include preparing a press line which may include cleaning the line, providing the materials, programming the press, the like, or a combination thereof. The line may include a hopper into which the material is loaded. The hopper may supply the material onto a belt or another device structured to distribute the materials onto a moving belt such as a conveyor belt. The distribution may be continuous. The distribution may be even or uneven. The process may include adding moisture to the materials distributed onto the moving belt, as was described above with respect to the batch process. The moisture may be added once or more times to the material before the material is pressed. Alternatively, the moisture may be added one or more times while the material is being pressed in the continuous process. The process may include adding a predetermined amount of heat for a predetermined amount of time while the material is being pressed.

The process may include pressing the materials with a press, holding the press, and releasing the press, each action lasting for a predetermined amount of time. After the press is released, the compressed layer may be removed from the press, cooled, unloaded, cut, or a combination thereof in a variable order.

The press may include one or more conveyor belts or other moving parts configured to hold and move the initial material to be pressed, a dispensing mechanism configured to spread the initial material onto the conveyor belt or moving part, one or more rollers configured to press the initial material into the compressed substrate layer. The rollers may be belts such as metal belts.

The process may include a boundary-forming device or another mechanism configured to limit spreading of the initial material beyond a predetermined line or area such that the offal is minimal or none. If offal appears, the offal material may be reintroduced into the process as the initial material.

In an alternative embodiment, a batch press may be used to mimic a continuous process. The fiber may be loaded onto a conveyor belt while the conveyor belt is not conveying. Once loaded with the fiber to a predetermined volume, height, or both, the material may be provided to the pressing rollers of the press.

Additionally, the process may include a post-pressing stage regardless of which type of press was used to produce the compressed layers. The post-pressing stage may be an assembly stage. The assembly stage may include layer cutting, trimming, measuring, dimensioning stacking, layering, adjusting, inserting, the like, or a combination thereof. The post-pressing stage may include removing offal, one or more edges, stray fibers, or a combination thereof by cutting or otherwise. The removal may be done on each layer pre-stacking or post-stacking.

The process may include cutting the layers into desirable dimensions and shapes to prepare a desirable number of layers to be stacked on top of each other. The process may include stacking two or more layers on top of one another. The process may include aligning the layers once stacked. The process may include securing the discreet layers together, for example with a dissolvable glue or a dissolvable tie, or another mechanism, as described herein.

Alternatively, the process may include stacking uncut, untrimmed layers on top of one another. Once the predetermined number of layers is stacked, the process may include cutting, trimming, removing offal, edges, stray fibers, etc.

The process may also include inserting the stacked layers into the wrapping disclosed above. The process may include sealing the wrapping, securing the wrapping, securing the stacked layers to one another, securing the stacked layers in the wrapping, or a combination thereof.

The hydroponic substrate disclosed herein is shelf stable and storage stable. The wrapping-including or wrapping-free substrate may be inserted in a protective film for storage and transportation purposes. Additionally, the substrate may be sterile due to the heat and/or steam during the pressing stage, and subsequent handling of the substrate. This provides an additional advantage as a sterile hydroponic substrate does not provide a source of possible contamination as do some prior art media like coco coir substrates.

A hydroponic substrate disclosed herein may be used for propagation, germination, cultivation, growth of a variety of species of plants including, but not limited to, high value crops, soft fruits such as berries, vegetables such as tomatoes, peppers, cucumbers, herbs such as flowering herbs such as flowering plants in the family Cannabaceae, microgreens or vegetables and herbs harvested at the seedling stage before development of their true leaves. The substrate disclosed herein may be used for food production in various settings including locally grown produce.

### EXAMPLES

Besides examples 1-113 discussed below, various examples discussed above and shown in FIGS. 1-39B were prepared as discussed above. For the purposes of this application, the examples listed above and shown in the Figures demonstrate technical solutions and advantages of the herein-disclosed hydroponics substrate.

### Examples 1-16

Examples 1-16 were prepared using a batch compression process according to a batch method described above. The batch process was designed to mimic the continuous process. The fiber was laid on the conveyor belt, water was added to the fiber, and compression was used to form a substrate layer. The layer was cut into desirable dimensions referenced in the Tables below. The “line speed” and “water added” press compression parameters were varied between examples, as is indicated below in Table 6. The data in Table 6 is for dry compressed state. Examples 1-16 each included a top and bottom crust.

TABLE 6
Properties of examples 1-16 produced on a continuous press by a batch process

| | Line | Water | | Dimensions: | Density | Volume |
|---|---|---|---|---|---|---|
| Example | Speed | added | Weight | length × width × | [lb/ft³/ | [cm³/ |
| no. | [mm/s] | [ml/m²] | [g/lbs] | height [cm] | kg/m³] | ft³] |
| 1 | 70 | 80 | 616.64/1.36 | 51 × 51 × 0.6 | 24.7/395.7 | 1560.6/0.06 |
| 2 | | | 617.08/1.36 | 51 × 50 × 0.6 | 25.2/403.7 | 1530/0.05 |
| 3 | | | 617.21/1.36 | | | |
| 4 | | | 620.60/1.37 | | 25.3/405.3 | |
| 5 | 100 | | 623.72/1.38 | | 25.4/406.9 | |
| 6 | | | 325.10/1.38 | 50 × 50 × 0.7 | 22.3/357.2 | 1750/0.06 |
| 7 | | | 321.75/1.37 | 51 × 50 × 0.6 | 25.4/406.9 | 1530/0.05 |
| 8 | | | 624.31/1.38 | 51 × 51 × 0.6 | 25.0/400.5 | 1560.06/0.06 |
| 9 | 70 | 120 | 618.85/1.36 | | 24.8/397.3 | |
| 10 | | | 615.46/1.36 | | 24.6/394.1 | |
| 11 | | | 620.26/1.37 | | 24.8/397.3 | |
| 12 | | | 624.00/1.38 | | 25.0/400.5 | |
| 13 | 100 | | 625.03/1.38 | | | |
| 14 | | | 620.58/1.37 | | 24.8/397.3 | |
| 15 | | | 623.21/1.37 | | 24.9/398.9 | |
| 16 | | | 620.56/1.37 | | 24.8/397.3 | |

### Examples 17-40

Examples 3, 7, 11, and 14 were duplicated to produce multi-layer slabs. The slabs for each original example 3, 7, 11, and 14 had the same starting properties shown in Table 6 above, but differed in an amount of layers (1-6), which affected the weight, fiber weight, noted in Table 7, and additional properties such as volumetric water content (VWC). Each example 17-40 had a length of 7.5 cm and width of 7.5 cm dry compressed and about 8×8 cm when hydrated. All properties listed in Table 7 are for dry compressed state. DC stands for Dry Compressed.

TABLE 7
Slab properties of examples 3, 7, 11, and
14 after compression, before hydration

| Slab | Original | | DC | DC Fiber | DC Substrate |
|---|---|---|---|---|---|
| Example | Example | Number | Weight | Weight | Height |
| no. | no. | of layers | [g] | [g] | [cm] |
| 17 | 3 | 1 | 14.87 | 13.98 | 0.6 |
| 18 | | 2 | 30.49 | 28.66 | 1.3 |
| 19 | | 3 | 45.27 | 42.55 | 2.0 |
| 20 | | 4 | 60.51 | 56.88 | 2.7 |
| 21 | | 5 | 71.54 | 67.24 | 3.3 |
| 22 | | 6 | 84.64 | 79.56 | 4.0 |
| 23 | 7 | 1 | 14.12 | 13.27 | 0.6 |
| 24 | | 2 | 26.67 | 25.07 | 1.3 |
| 25 | | 3 | 47.34 | 44.50 | 2.0 |
| 26 | | 4 | 59.90 | 56.31 | 2.7 |
| 27 | | 5 | 78.62 | 73.90 | 3.5 |
| 28 | | 6 | 93.31 | 87.71 | 4.1 |
| 29 | 11 | 1 | 14.93 | 14.03 | 0.6 |
| 30 | | 2 | 19.73 | 27.95 | 1.3 |
| 31 | | 3 | 43.05 | 40.47 | 1.9 |
| 32 | | 4 | 59.05 | 55.51 | 2.6 |
| 33 | | 5 | 76.62 | 72.02 | 3.1 |
| 34 | | 6 | 86.39 | 91.21 | 3.8 |
| 35 | 14 | 1 | 14.61 | 13.73 | 0.6 |
| 36 | | 2 | 30.22 | 28.41 | 1.4 |
| 37 | | 3 | 44.72 | 42.04 | 2.0 |
| 38 | | 4 | 58.13 | 54.64 | 2.7 |
| 39 | | 5 | 72.44 | 68.09 | 3.4 |
| 40 | | 6 | 88.80 | 83.47 | 3.9 |

The slabs of examples 17-40 were then hydrated to measure several properties after hydration. The starting moisture content of each sample was about 6 wt. %. The Water Held parameter was calculated from the layer's Hydrated Weight and Dry Compressed Weight from Table 7. The Water Held parameter was used to assess the volumetric water content (VWC) of each example, which was calculated from the Water Held divided by the volume of each example. The Expanded Dry Density was calculated from the total density and water content. The results are shown in Table 8 below. All properties listed in Table 8 are for the hydrated state.

TABLE 8
Slab properties of examples 17-40 after hydration

| | | | | | Volumetric | Hydrated |
|---|---|---|---|---|---|---|
| | | Hydrated | Water | Moisture | Water | Substrate |
| Example | Number | Weight | Held | Content | Content | Height |
| no. | of layers | [g] | [ml] | [wt. %] | [g/cm³] | [cm] |
| 17 | 1 | 177.65 | 172.8 | 93 | 0.94 | 2.7 |
| 18 | 2 | 307.41 | 276.9 | 91 | 0.83 | 5.2 |
| 19 | 3 | 383.37 | 338.1 | 89 | 0.71 | 6.5 |
| 20 | 4 | 646.09 | 403.6 | 88 | 0.75 | 8.4 |
| 21 | 5 | 519.4 | 447.9 | 87 | 0.74 | 9.5 |
| 22 | 6 | 566.77 | 482.1 | 76 | 0.68 | 11.1 |
| 23 | 1 | 180.99 | 166.9 | 93 | 0.90 | 2.9 |
| 24 | 2 | 280.09 | 253.4 | 91 | 0.84 | 4.7 |
| 25 | 3 | 399.49 | 352.2 | 89 | 0.80 | 6.9 |
| 26 | 4 | 463.94 | 404.0 | 88 | 0.74 | 8.5 |
| 27 | 5 | 541.06 | 462.4 | 86 | 0.72 | 10.0 |
| 28 | 6 | 588.60 | 495.3 | 85 | 0.70 | 11.1 |
| 29 | 1 | 179.52 | 164.6 | 92 | 0.89 | 2.9 |
| 30 | 2 | 290.88 | 261.2 | 90 | 0.82 | 5.0 |
| 31 | 3 | 378.74 | 335.7 | 89 | 0.82 | 6.5 |
| 32 | 4 | 453.18 | 194.1 | 88 | 0.76 | 8.1 |
| 33 | 5 | 529.64 | 453.0 | 86 | 0.73 | 9.7 |
| 34 | 6 | 564.80 | 478.4 | 86 | 0.67 | 11.1 |
| 35 | 1 | 162.04 | 147.4 | 92 | 0.93 | 2.5 |
| 36 | 2 | 283.45 | 253.2 | 90 | 0.86 | 4.5 |
| 37 | 3 | 350.53 | 305.8 | 88 | 0.82 | 5.8 |
| 38 | 4 | 431.48 | 373.4 | 87 | 0.79 | 7.4 |
| 39 | 5 | 499.14 | 426.7 | 86 | 0.77 | 8.7 |
| 40 | 6 | 574.03 | 485.2 | 85 | 0.71 | 10.6 |

### Examples 41-64

Additional examples 41-64 were prepared using the original examples 3, 7, 11, and 14. Each example 41-64 was hydrated after compression and cutting. Each hydrated example measured 8 cm in length and between 7.9 and 8.2 cm in width, majority of examples having 8 cm in width hydrated. The same properties were measured for examples 41-64 as for examples 17-40. The results are shown in Table 9 below. All properties listed in Table 9 are for the hydrated state.

TABLE 9
Slab properties of examples 41-64 after hydration

| | | | | | | | |
|---|---|---|---|---|---|---|---|
| | | | | | Volumetric | Expanded | Hydrated |
| | | Hydrated | Water | Moisture | Water | Dry | Substrate |
| Examples | Number | Weight | Held | Content | Content | Density | Height |
| no. | of layers | [g] | [ml] | [wt. %] | [ml/cm³] | [lb/ft³] | [cm] |

| | | | | | | |
|---|---|---|---|---|---|---|
| 41 | 1 | 177.65 | 162.8 | 0.94 | 5.37 | 2.7 |
| 42 | | 179.52 | 164.6 | 0.89 | 5.02 | 2.9 |
| 43 | | 180.99 | 166.9 | 0.90 | 4.75 | 2.9 |
| 44 | | 162.04 | 147.4 | 0.93 | 5.77 | 2.5 |
| 45 | 2 | 307.41 | 276.9 | 0.83 | 5.72 | 5.2 |
| 46 | | 290.88 | 261.2 | 0.82 | 5.80 | 5.0 |
| 47 | | 280.09 | 253.4 | 0.84 | 5.54 | 4.7 |
| 48 | | 283.45 | 253.2 | 0.86 | 6.39 | 4.5 |
| 49 | 3 | 383.37 | 338.1 | 0.81 | 6.79 | 6.5 |
| 50 | | 378.74 | 335.7 | 0.81 | 6.46 | 6.5 |
| 51 | | 399.49 | 352.2 | 0.80 | 6.69 | 6.9 |
| 52 | | 350.53 | 305.8 | 0.82 | 7.42 | 5.8 |
| 53 | 4 | 464.09 | 403.6 | 0.75 | 7.03 | 8.4 |
| 54 | | 453.18 | 394.1 | 0.76 | 7.11 | 8.1 |
| 55 | | 463.94 | 404.0 | 0.74 | 6.87 | 8.5 |
| 56 | | 431.48 | 373.4 | 0.79 | 7.66 | 7.4 |
| 57 | 5 | 519.40 | 447.9 | 0.74 | 7.35 | 9.5 |
| 58 | | 529.64 | 453.0 | 0.73 | 7.70 | 9.7 |
| 59 | | 541.06 | 462.4 | 0.72 | 7.67 | 10.0 |
| 60 | | 499.14 | 426.7 | 0.77 | 8.12 | 8.7 |
| 61 | 6 | 566.70 | 482.1 | 0.68 | 7.44 | 11.1 |
| 62 | | 564.80 | 478.4 | 0.67 | 7.59 | 11.1 |
| 63 | | 588.60 | 495.3 | 0.70 | 8.20 | 11.1 |
| 64 | | 574.03 | 485.2 | 0.71 | 8.07 | 10.6 |

FIG. 14 shows the volumetric water content (VWC) for examples 43, 47, 51, 55, 59, and 63. As can be observed, increasing the amount of layers affects the VWC. The plot shows a linear decrease in VWC with increasing number of layers.

FIG. 15 shows the expanded hydrated substrate height for examples 42, 46, 50, 54, 58, and 62. As can be observed, increasing the amount of layers affects the expanded height. The plot shows a linear increase in the expanded height with increasing number of layers 58, and 62. As can be observed, increasing the amount of layers affects the expanded height. The plot shows a linear increase in the expanded height with increasing number of layers.

### Examples 65-75

TABLE 10
Physical properties of examples 65-75

| | | | | Dry | Dry | | | Hydrated | Hydrated |
|---|---|---|---|---|---|---|---|---|---|
| | Total | Container | Air | Bulk | Bulk | | Mass Wetness | Bulk | Bulk |
| | Porosity | Capacity | Space | Density | Density | | [g water:g | Density | Density |
| Example No. | [%] | [%] | [%] | [kg/m³] | [lbs/ft³] | MC [%] | dry matter] | [kg/m³] | [lbs/ft³] |
| 65 | 97.35 | 31.74 | 65.61 | 49.7 | 3.10 | 56.95 | 1.32 | 370 | 22.91 |
| 66 | 96.12 | 33.67 | 62.45 | 54.5 | 3.34 | 54.11 | 1.18 | 390 | 24.35 |
| 67 | 97.60 | 33.16 | 64.44 | 50.1 | 3.13 | 56.42 | 1.29 | 380 | 23.83 |
| Mean 65-57 | 97.02 | 32.85 | 64.17 | 51.4 | 3.19 | 55.83 | 1.27 | 380 | 23.70 |
| 68 | 98.13 | 68.15 | 29.99 | 110.7 | 6.91 | 3.91 | 0.04 | 690 | 43.00 |
| 69 | 94.80 | 64.79 | 30.01 | 99.3 | 6.20 | 3.94 | 0.04 | 650 | 40.57 |
| 70 | 95.97 | 63.53 | 32.45 | 101.9 | 6.36 | 3.69 | 0.04 | 640 | 40.02 |
| 71 | 97.36 | 63.77 | 33.59 | 108.9 | 6.80 | 3.99 | 0.04 | 650 | 40.54 |
| 72 | 94.16 | 62.22 | 31.94 | 94.5 | 5.90 | 4.03 | 0.04 | 670 | 41.82 |
| Mean 68-72 | 96.08 | 64.49 | 31.59 | 103.1 | 6.43 | 3.91 | 0.04 | 660 | 41.19 |
| 73 | 96.36 | 67.10 | 29.26 | 86.5 | 5.40 | 10.14 | 0.11 | 760 | 47.29 |
| 74 | 94.26 | 69.11 | 25.15 | 88.4 | 5.52 | 10.29 | 0.11 | 780 | 48.66 |
| 75 | 95.16 | 68.39 | 26.77 | 88.3 | 5.51 | 10.82 | 0.12 | 770 | 48.20 |
| Mean 73-75 | 95.26 | 68.20 | 27.06 | 87.7 | 5.47 | 10.42 | 0.12 | 770 | 48.05 |
| Mean 65-75 | 96.26 | 56.51 | 39.61 | 84.8 | 5.23 | 20.06 | 0.41 | 610 | 38.15 |

Additional examples were prepared on a batch press mimicking the continuous process. The initial bulk density of examples 65-67 was 4 lbs/ft³ (64.1 kg/m³). The initial density of examples 68-72 varied. The initial density of examples 73-75 was 6 lbs/ft³ (96.1 kg/m³). The produced substrates were tested using the NCSU Porometer analysis, referenced above, to obtain physical properties of the compressed substrate. The testing was done by taking the substrate and inserting it in a container of specific dimensions: each example in a 3×3 inches (7.6×7.6 cm) aluminum cylinder. The results are listed in Table 10.

### Examples 76-101

Examples 76-101 were prepared on the batch press by a method described above with respect to examples 65-75. After compression, the substrate was cut into one-layer slabs having dimensions and properties shown in the Table 11 below. The examples 76-101 had a higher initial density than examples 65-75 as they were subjected to higher compression.

TABLE 11
Initial dimensions and physical properties
of single-layer slabs of examples 76-101

| | Starting | | | | Total |
|---|---|---|---|---|---|
| | Mass | Length | Width | Height | Volume |
| | Unit | | | | |
| Example No. | [g] | [cm] | [cm] | [cm] | [mL] |
| 76 | 8.11 | 3.8 | 3.8 | 6.8 | 98.19 |
| 77 | 9.79 | 3.8 | 3.8 | 6.8 | 98.19 |
| 78 | 9.87 | 3.8 | 3.8 | 6.8 | 98.19 |
| 79 | 9.70 | 3.8 | 3.8 | 6.8 | 98.19 |
| Mean | 9.37 | 3.8 | 3.8 | 6.8 | 98.19 |
| 80 | 1.53 | 2.5 | 2.5 | 2.5 | 15.63 |
| 81 | 1.65 | 2.5 | 2.5 | 2.5 | 15.63 |
| 82 | 1.35 | 2.5 | 2.5 | 2.5 | 15.63 |
| 83 | 1.45 | 2.5 | 2.5 | 2.5 | 15.63 |
| Mean | 1.50 | 2.5 | 2.5 | 2.5 | 15.63 |
| 84 | 5.43 | 2.8 | 2.7 | 6.8 | 51.41 |
| 85 | 5.62 | 2.8 | 2.8 | 6.8 | 53.31 |
| 86 | 4.73 | 2.7 | 2.8 | 6.8 | 51.41 |
| 87 | 5.93 | 2.8 | 2.8 | 6.8 | 53.31 |
| Mean | 5.43 | 2.8 | 2.8 | 6.8 | 52.36 |
| 88 | 1.05 | 2.8 | 2.6 | 2.0 | 14.56 |
| 89 | 1.05 | 2.5 | 2.7 | 2.0 | 13.50 |
| 100 | 1.25 | 2.5 | 2.5 | 2.0 | 12.50 |
| 101 | 1.45 | 2.4 | 2.4 | 2.0 | 11.52 |
| Mean | 1.20 | 2.6 | 2.6 | 2.0 | 13.02 |

Examples 76-101 were further hydrated and tested to assess porometer properties. The test was adopted from the University of Florida, Young Plant Research Center, “Particle Size Testing for Propagation Substrates” published in Ofa Grower, March/April 2012, No. 932. The testing did not constrain the substrates to a container.

The results of the testing are shown in Table 12 below.

TABLE 12
Physical properties of examples 76-101

| | | Wet | | | | | | | |
|---|---|---|---|---|---|---|---|---|---|
| | Wet | Mass - | | | | | | Dry | Dry |
| | Mass - | 30 min | | Dry | Total | Air | Container | Bulk | Bulk |
| | Initial | Drain | Drained | Mass | Porosity | Space | Capacity | Density | Density |
| | Unit | | | | | | | | |
| Example No. | [g] | [g] | [g] | [g] | [%] | [%] | [%] | [g/L] | [lbs/ft³] |
| 76 | 102.67 | 82.17 | 20.5 | 8.03 | 96.38 | 20.88 | 75.51 | 81.78 | 5.10 |
| 77 | 102.60 | 77.37 | 25.23 | 9.67 | 94.64 | 25.69 | 68.95 | 98.48 | 6.14 |
| 78 | 107.95 | 82.58 | 25.37 | 9.77 | 99.99 | 25.84 | 74.15 | 99.50 | 6.21 |
| 79 | 101.84 | 81.17 | 20.67 | 9.61 | 93.93 | 21.05 | 72.88 | 97.87 | 6.11 |
| Mean | 103.77 | 80.82 | 22.94 | 9.27 | 96.23 | 23.36 | 72.87 | 94.41 | 5.89 |
| 80 | 16.88 | 13.73 | 3.15 | 1.50 | 98.43 | 20.16 | 78.27 | 96.00 | 5.99 |
| 81 | 15.77 | 12.62 | 3.15 | 1.60 | 90.69 | 20.16 | 70.53 | 102.4 | 6.39 |
| 82 | 16.85 | 13.69 | 3.16 | 1.34 | 99.26 | 20.22 | 79.04 | 85.76 | 5.35 |
| 83 | 16.85 | 13.41 | 3.44 | 1.40 | 98.88 | 22.02 | 76.86 | 89.60 | 5.59 |
| Mean | 16.59 | 13.36 | 3.23 | 1.46 | 96.82 | 20.64 | 76.18 | 93.44 | 5.83 |
| 84 | 61.83 | 52.14 | 9.69 | 4.89 | 110.76 | 18.85 | 91.91 | 95.12 | 5.93 |
| 85 | 62.31 | 52.54 | 9.77 | 5.13 | 107.26 | 18.33 | 88.93 | 96.23 | 6.00 |
| 86 | 55.88 | 47.12 | 8.76 | 4.39 | 100.16 | 17.04 | 83.12 | 85.40 | 5.33 |
| 87 | 63.65 | 53.67 | 9.98 | 5.55 | 108.98 | 18.72 | 90.26 | 104.1 | 6.50 |
| Mean | 60.92 | 51.37 | 9.55 | 4.99 | 106.81 | 18.24 | 88.57 | 95.21 | 5.94 |
| 88 | 20.34 | 14.99 | 5.35 | 1.33 | 130.56 | 36.74 | 93.82 | 91.35 | 5.70 |
| 89 | 14.73 | 12.93 | 1.80 | 1.19 | 100.30 | 13.33 | 86.96 | 88.15 | 5.50 |
| 100 | 14.64 | 11.13 | 3.51 | 0.97 | 109.36 | 28.08 | 81.28 | 77.60 | 4.84 |
| 101 | 14.94 | 11.61 | 3.33 | 1.03 | 120.75 | 28.91 | 91.84 | 89.41 | 5.58 |
| Mean | 16.16 | 12.67 | 3.50 | 1.13 | 115.46 | 26.86 | 88.59 | 86.63 | 5.40 |

### Examples 102-105 and Comparative Examples f1-f4

Examples 102-105 were compressed according to the process described herein, forming crusts, while comparative examples f1-f4 were tested as loose media, hand-pressed together. The comparative examples did not include any crust as disclosed herein. All examples and comparative examples had the same composition (70 wt. % wood fiber and 30 wt. % peat) and substantially similar MC. All examples and comparative examples were placed in beakers having the same amount of water (300 ml). Time was measured until each example/comparative example completely submerged. As was demonstrated, the loose media of comparative examples f1-f4 demonstrated hydrophobic behavior and did not sink for a long time. In contrast, examples 102-105 sank completely within 2 minutes.

TABLE 13
Compressed vs. loose state of medium's
effect on hydrophilicity/hydrophobicity

| Example/ | | | | | Time |
|---|---|---|---|---|---|
| Comparative | Compressed/ | Weight | Density | MC | to sink |
| Example No. | Loose | [g] | [lbs/ft³] | [wt. %] | [min] |
| 102 | Compressed | 4 | 25 | 8.7 | 1.60 |
| 103 | Compressed | 4 | 25 | 8.7 | 1.68 |
| 104 | Compressed | 4 | 25 | 8.7 | 1.43 |
| 105 | Compressed | 4 | 25 | 8.7 | 2.05 |
| f1 | Loose | 4 | 2.7 | 9.07 | 195 |
| f2 | Loose | 4 | 2.7 | 9.07 | 205 |
| f3 | Loose | 4 | 2.7 | 9.07 | 250 |
| f4 | Loose | 4 | 2.7 | 9.07 | 250 |

### Examples 106-110 and Comparative Examples g1-g5

Examples 106-110 were compressed according to the process described herein, forming crusts, as a sheet and divided into five portions, each portion representing one of the examples 106-110. Comparative examples g1-g5 were prepared as loose media and compressed by hand into a shape of a rectangular layer of the same dimensions as examples 106-110. The hand compression of the loose fiber was without added heat or steam. The comparative examples did not include any crust as disclosed herein.

For break testing, each example and comparative example were placed on two parallel beams. A gap between the beams was 3 inches. Each example and comparative example were placed such that their ends were supported on the beams and a middle portion of each example and comparative example was suspended above the gap. Force was applied to the middle portion until the middle portion cracked. Force 1 meter by Wagner FDIX was used to measure the applied force at cracking point also called breaking force, peak force, or maximum force. Table 14 shows results. As can be observed from the data, a much greater force was needed to compromise structural stability of the compressed examples 106-110 than the loose material comparative examples g1-g5.

TABLE 14
Breaking Force needed to break examples
106-110 and comparative examples g1-g5

| Example/Comparative | Compressed/ | Breaking |
|---|---|---|
| Example No. | Loose | Force [N/cm] |
| 105 | Compressed | 26 |
| 106 | Compressed | 29.5 |
| 107 | Compressed | 25.5 |
| 108 | Compressed | 30 |
| 109 | Compressed | 31.5 |
| g1 | Loose | 2.5 |
| g2 | Loose | 0.5 |
| g3 | Loose | 1.5 |
| g4 | Loosc | 5 |
| g5 | Loose | 0.5 |

### Examples 111-113 and Comparative Examples h1-h3

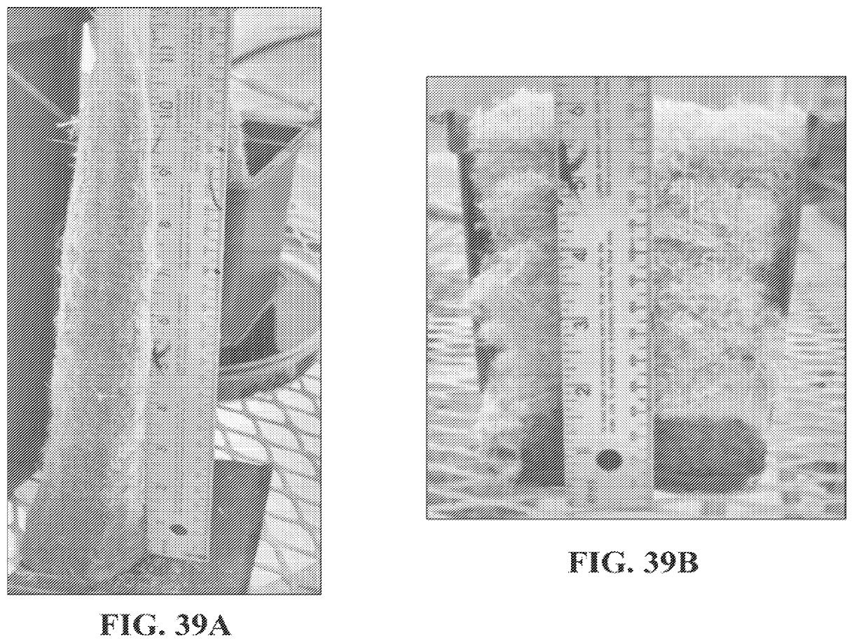

Examples 111-113 were compressed according to the process described herein, forming crusts, as a sheet and divided into five portions, each portion representing one of the examples 111-113. Comparative examples h1-h3 were prepared as loose media and compressed by hand into a container depicted in FIG. 39B. The compression of the loose media was without added heat or steam. The comparative examples did not include any crust as disclosed herein.

Water wicking from the bottom of the examples and comparative examples was assessed by submerging each example and comparative examples in 3 cm of water for 30 minutes before removing them and measuring water height. The MC of the loose material was 12 wt. % while the MC of the compressed examples was 6 wt. %. Results are shown in Table 15. As can be observed from the comparative data, the examples 111-113 have much greater (about 5 times greater) wicking ability to lead water than the loose comparative examples h1-h3. Additionally, the difference in the wicking ability of example 111 and comparative example h1 is shown in FIGS. 39A and 39B, respectively. Despite having a lower MC, the examples 111-113 wicked water much better than the comparative examples with higher MC.

TABLE 15
Water wicking of examples 111-113
and comparative examples h1-h3

| Example/Comparative | Compressed/ | Water Height above 3 |
|---|---|---|
| Example No. | Loose | cm water depth [cm] |
| 111 | Compressed | 24.5 |
| 112 | Compressed | 23.4 |
| 113 | Compressed | 24.8 |
| h1 | Loose | 1.5 |
| h2 | Loose | 0.1 |
| h3 | Loose | 0.5 |

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1.-52. (canceled)

53. A hydroponic substrate comprising:
a three-dimensional self-supporting, vertically stable fibrous body comprising
an inner portion having a first fiber density and
an outer crust portion comprising densified fiber having a second fiber density,
the second fiber density being different than the first fiber density,
the inner portion and the outer crust portion forming horizontal and vertical liquid pathways structured to distribute liquid throughout the body.

54. The hydroponic substrate of claim 53, wherein the hydroponic substrate is free of a wrapping.

55. The hydroponic substrate of claim 53, wherein the hydroponic substrate is a single layer hydroponic substrate.

56. The hydroponic substrate of claim 53, wherein the hydroponic substrate includes wood, bark, coir, sisal, jute, straw, rice hulls, hemp, alfalfa, flax, peat, hammermilled fiber, sawdust, compost, manure, paper, biostimulant(s), fertilizer(s), ceramic particle(s), or a combination thereof.

57. The hydroponic substrate of claim 53, wherein a ratio of the first fiber density to the second fiber density is about 0.3-0.5.

58. The hydroponic substrate of claim 53, wherein the hydroponic substrate is rewettable while being free of a surfactant.

59. The hydroponic substrate of claim 53, wherein the outer crust has a smaller average pore size than an average pore size of the inner portion.

60. The hydroponic substrate of claim 53, wherein the hydroponic substrate includes coir and wood fiber in a weight ratio of 90:10 to 10:90 wt. %, based on the total weight of the substrate.

61. A hydroponic substrate comprising:
a rewettable three-dimensional self-supporting fibrous structure including two or more compressed layers disposed in a vertically stacked arrangement, each layer comprising:
an inner portion having a first fiber density, and
an outer crust portion comprising a second fiber density, the second fiber density being at least about 2.5% higher than the first fiber density.

62. The hydroponic substrate of claim 61, wherein the hydroponic substrate is hydratable and structured to have vertical stability after hydration.

63. The hydroponic substrate of claim 61, wherein the densified fiber has a pore structure arranged to form substantially lateral liquid pathways.

64. The hydroponic substrate of claim 61, wherein the hydroponic substrate is free of an added binder.

65. The hydroponic substrate of claim 61, wherein the two or more compressed layers have independently different properties.

66. The hydroponic substrate of claim 61, wherein the hydroponic substrate comprises wood fiber, coir fiber, or a combination thereof.

67. The hydroponic substrate of claim 61, wherein the two or more compressed layers have generally the same dimensions and cooperate to form a grow cube.

68. The hydroponic substrate of claim 61, wherein the first fiber density to the second fiber density ratio is about 0.3-0.5.

69. The hydroponic substrate of claim 61, wherein the densified fiber includes smaller pores on average than the inner portion.

70. The hydroponic substrate of claim 61, wherein the hydroponic substrate includes wood, bark, coir, sisal, jute, straw, rice hulls, hemp, alfalfa, flax, peat, hammermilled fiber, sawdust, compost, manure, paper, biostimulant(s), fertilizer(s), ceramic particle(s), or a combination thereof.

71. A rewettable hydroponic substrate comprising:
a plurality of discreet layers stacked on top of one another such that the layers are stationary with respect to one another, each layer comprising compressed fibrous material structured to have lateral liquid pathways and horizontal liquid pathways, the discreet layers cooperating together to form the rewettable hydroponic substrate.

72. The hydroponic substrate of claim 71, wherein at least one of the layers comprises an inner portion having a first fiber density and an outer crust portion comprising densified fiber having a second fiber density, a ratio of the first fiber density to the second fiber density being about 0.3-0.5.

73. The hydroponic substrate of claim 71, wherein the plurality of discreet layers includes a top layer having a substantially uniform and level surface.

74. The hydroponic substrate of claim 71, wherein the layers have substantially even density throughout their length.

75. The hydroponic substrate of claim 71, wherein the hydroponic substrate includes wood, bark, coir, sisal, jute, straw, rice hulls, hemp, alfalfa, flax, peat, hammermilled fiber, sawdust, compost, manure, paper, biostimulant(s), fertilizer(s), ceramic particle(s), or a combination thereof.

76. The hydroponic substrate of claim 71, wherein the discreet layers are secured together.

77. The hydroponic substrate of claim 71, further comprising a wrapping enclosing the plurality of discreet layers.

78. The hydroponic substrate of claim 77, wherein the wrapping is a loose wrapping covering a top side of the substrate.
